(19) United States
(12) Patent Application Publication
(10) Pub. No.: US 2015/0090397 A1
(43) Pub. Date: Apr. 2, 2015

(54) FLEXOGRAPHIC PRINTING PLATE PRECURSOR FOR LASER ENGRAVING, PROCESS FOR PRODUCING SAME AND PROCESS FOR MAKING FLEXOGRAPHIC PRINTING PLATE

(71) Applicant: FUJIFILM CORPORATION, Tokyo (JP)

(72) Inventor: Yousuke MATSUMOTO, Haibara-gun (JP)

(73) Assignee: FUJIFILM CORPORATION, Tokyo (JP)

(21) Appl. No.: 14/499,560

(22) Filed: Sep. 29, 2014

(30) Foreign Application Priority Data
Sep. 30, 2013 (JP) 2013-204192

(51) Int. Cl. B41C 1/00; B32B 38/10; B32B 38/00; B32B 37/00; B32B 37/24

(52) U.S. Cl. CPC B41C 1/00; B32B 37/025; B32B 37/24; B32B 38/0036; B32B 38/10; B32B 38/0008; B32B 2037/243; B32B 2038/0076; B32B 2310/0843; B32B 2329/04; B32B 2355/00; B32B 2363/00; B32B 2379/00
USPC 156/246; 101/401.1; 427/385.5; 156/60

(57) ABSTRACT

Disclosed is a process for producing a flexographic printing plate precursor for laser engraving, comprising, in order, steps of: forming a curable resin composition layer, which comprises (Component A) an ethylenically unsaturated compound, (Component B) a polymerization initiator, and (Component C) a binder, on a temporary support; forming a resin layer, which has an oxygen transmission coefficient of equal to or lower than 15 cm³·cm/m²·day·atm and a Shore A hardness of 20° to 70°, on the curable resin composition layer; and curing the curable resin composition layer.

### CROSS-REFERENCE TO RELATED APPLICATION

This application claims priority under U.S.C. 119 from Japanese Patent Application No. 2013-204192 filed on Sep. 30, 2013, the entire content of which is incorporated by reference herein.

### TECHNICAL FIELD

The present invention relates to a flexographic printing plate precursor for laser engraving and a process for producing the same, and a process for making a flexographic printing plate.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder.

As lasers used for a process for making a plate by directly laser-engraving the relief-forming layer, in addition to a high-power carbon dioxide laser, an inexpensive and small-sized semiconductor laser has been developed and used. The engraving residue of the relief-forming layer that is generated as a result of engraving using such lasers is removed by steps of rinsing or washing with water and the like. JP-A-2004-314334 and JP-A-2013-39705 disclose a flexographic printing plate precursor for laser engraving which makes it easy to remove the engraving residue.

JP-A-2004-314334 discloses a process for producing a printing plate precursor for laser engraving that comprises steps of forming a photosensitive resin composition layer, which comprises (a) a resin that stays in liquid form at 20° C., (b) an organic compound that has a polymerizable unsaturated group, (c) an inorganic porous substance, (d) a hydrogen abstraction-type photopolymerization initiator, and (d) a degradable photopolymerization initiator and stays in liquid form at 20° C., on a sheet-like or cylindrical support; and curing the photosensitive resin composition layer by irradiating the entire surface of the formed photosensitive resin composition layer with light in the atmosphere.

JP-A-2013-39705 discloses a process for producing a flexographic printing plate precursor for laser engraving that comprises steps of forming a thermocurable layer containing (Component A) a polymerizable compound and (Component B) a thermopolymerization initiator; laminating an oxygen barrier film, which exhibits oxygen transmissivity of equal to or lower than 30 ml/m²·day·atm at 25° C. and 1 atm, on the thermocurable layer; and thermally curing the thermocurable layer.

### SUMMARY OF THE INVENTION

### Problems to be Solved by the Invention

The present inventors repeated thorough examination by paying attention to a fact that the production process described in JP-A-2004-314334 has a problem in that the curing reaction of the polymerizable unsaturated compound is inhibited by oxygen in the atmosphere and to a fact that the production process described in JP-A-2013-39705 has problems in that the process requires a step of removing the oxygen barrier film, and the adhesiveness in the interface between the oxygen barrier film and the thermocurable layer is insufficient, and thus the laser-engraved relief layer is easily deformed.

Moreover, the present inventors found that in a flexographic printing plate precursor for laser engraving cured by known radical polymerization, when a cushion layer is provided to the plate cylinder side of a relief-forming layer to be laser-engraved, the curing reaction of the polymerizable unsaturated compound is inhibited due to oxygen in the atmosphere in the interface therebetween, and this leads to a problem in that curing is not sufficiently performed.

Objects to be solved by the present invention are to provide a flexographic printing plate precursor for laser engraving in which the adhesiveness in the interface between a cushion layer and a relief-forming layer is sufficient when the cushion layer is provided to a plate cylinder side of the relief-forming layer to be laser-engraved, and a laser-engraved relief layer is not easily deformed, to provide a process for producing the flexographic printing plate precursor for laser engraving, and to provide a process for making a flexographic printing plate.

### Means to Solve the Problems

The above objects of the present invention have been achieved by the following <1>, <8> and <10>. Preferable embodiments <2> to <7> and <9> will also be described below.

<1> A flexographic printing plate precursor for laser engraving comprising a resin layer which has an oxygen transmission coefficient of equal to or lower than 15 cm³·cm/m²·day·atm and a Shore A hardness of 20° to 70°; and a cured layer of a curable resin composition which comprises (Component A) an ethylenically unsaturated compound, (Component B) a polymerization initiator, and (Component C) a binder,

<2> the flexographic printing plate precursor as described in <1>, wherein the cured layer of the curable resin composition further comprises (Component D) a photothermal conversion agent,

<3> the flexographic printing plate precursor as described in <2>, wherein Component D is carbon black,

<4> the flexographic printing plate precursor as described in any one of <1> to <3>, wherein the resin layer comprises an elastomer,

<5> the flexographic printing plate precursor as described in any one of <1> to <4>, wherein the resin layer comprises an elastomer selected from a group consisting of butyl rubber, epichlorohydrin rubber, nitrile rubber, plasticized polyvinyl alcohol, and a plasticized ethylene-polyvinyl alcohol copolymer,

<6> the flexographic printing plate precursor as described in any one of <1> to <5>, wherein a film thickness of the resin layer is 0.1 to 1.6 mm,

<7> the flexographic printing plate precursor as described in any one of <1> to <6>, wherein the curable resin composition comprises a resin, which stays in the form of a plastomer at 20° C., and a polyfunctional ethylenically unsaturated compound,

<8> a process for producing a flexographic printing plate precursor for laser engraving comprising, in order, steps of forming a curable resin composition layer, which comprises (Component A) an ethylenically unsaturated compound, (Component B) a polymerization initiator, and (Component C) a binder, on a temporary support; forming a resin layer, which has an oxygen transmission coefficient of equal to or lower than 15 cm³·cm/m²·day·atm and a Shore A hardness of 20° to 70°, on the curable resin composition layer; curing the curable resin composition layer; and peeling off the temporary support and laminating a substrate on the resin layer,

<9> the process for producing a flexographic printing plate precursor as described in <8>, wherein the step of forming a resin layer is a step of bonding a sheet-like resin layer onto the curable resin composition layer,

<10> a process for making a flexographic printing plate comprising steps of preparing the flexographic printing plate precursor as described in any one of <1> to <7>, and laser-engraving the flexographic printing plate precursor.

### DESCRIPTION OF EMBODIMENTS

### (Flexographic Printing Plate Precursor for Laser Engraving)

The flexographic printing plate precursor for laser engraving of the present invention has a resin layer which has an oxygen transmission coefficient of equal to or lower than 15 cm³·cm/m²·day·atm and a Shore A hardness of 20° to 70°, and a cured layer of a curable resin composition which comprises (Component A) an ethylenically unsaturated compound, (Component B) a polymerization initiator, and (Component C) a binder. It is preferable for these layers to be sequentially laminated on each other on a substrate.

Herein, the “substrate” may be either a material which is distributed together with the cured layer and the resin layer or a plate cylinder to which the cured layer and the resin layer are integrally attached at the time of making the plate.

By laser-engraving the printing plate precursor having the cured relief-forming layer, the “flexographic printing plate” is made.

In the present invention, the “relief layer” refers to a laser-engraved layer in the flexographic printing plate, that is, the crosslinked relief-forming layer having undergone laser engraving.

Moreover, in the present invention, the “relief-forming layer” refers to a layer obtained after curing the curable resin composition.

The flexographic printing plate precursor for laser engraving of the present invention has the cured layer of the curable resin composition, which comprises Component A to Component C, and the resin layer. These layers are placed on a substrate as necessary.

In the present invention, the cured layer of the curable resin composition is preferably a layer cured by heat and/or light and is more preferably a layer cured by heat. The curing reaction is based on a radical addition reaction of Component A initiated by Component B.

Moreover, the resin layer has a Shore A hardness of 20° to 70°, and accordingly, deformation of the relief of the relief printing plate is reduced.

The flexographic printing plate precursor of the present invention is explained in detail below.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit.

Furthermore, in the present invention, ‘parts by mass’ and ‘parts by weight’ have the same meaning and ‘mass %’ and ‘wt %’ have the same meaning.

Moreover, in the present invention a combination of two or more preferred embodiments explained below is a more preferred embodiment.

Furthermore, ‘(Component A) a polymer having a monomer unit derived from a conjugated diene-based hydrocarbon’ etc. are simply called ‘Component A’ etc.

The flexographic printing plate precursor for laser engraving of the present invention has a resin layer and a cured layer of a curable resin composition as layers essentially arranged in the precursor. The resin layer functions as a so-called cushion layer, and the cured layer of a curable resin composition is a relief-forming layer. When the relief-forming layer is laser-engraved, a relief layer having concavities and convexities formed on the surface thereof is formed. At the time of flexographic printing, the relief layer receives a printing ink and transfers the ink.

It is preferable for the resin layer and the cured layer of a curable resin composition to be laminated on each other in this order on a substrate. Hereinafter, the cured layer, the resin layer, and the substrate will be explained in detail.

### (Cured Layer of Curable Resin Composition)

The flexographic printing plate precursor of the present invention is a precursor for laser engraving, and the cured layer of the curable resin composition as the outermost layer thereof functions as a relief-forming layer by laser light.

The curable resin composition comprises, as essential components, (Component A) an ethylenically unsaturated compound, (Component B) a polymerization initiator, and (Component C) a binder. The cured layer of the curable resin composition becomes a relief-forming layer. Herein, the curing means include thermal curing and/or photo-curing, and it is preferable to use thermal curing. The curing reaction can be performed by causing polyaddition of Component A, which is an addition-polymerizable compound, by the polymerization-initiating action of Component B. Component C is a binder, and as Component C, a resin compatible with Component A and Component B is preferably used.

Hereinafter, Component A to Component C as essential components of the curable resin composition will be described in detail.

### <(Component A) Ethylenically Unsaturated Compound>

The curable resin composition used in the present invention comprises (Component A) an ethylenically unsaturated compound as an essential component. The ethylenically unsaturated compound is not particularly limited, and the compounds known to those skilled in the art are used. Preferably, radical-polymerizable compounds having at least 1 ethylenically unsaturated group at the molecular terminal thereof are used. The ethylenically unsaturated compounds are roughly classified into monofunctional ethylenically unsaturated compounds having only one ethylenically unsaturated group in a single molecule and polyfunctional ethylenically unsaturated compounds having two or more ethylenically unsaturated groups in a single molecule. The monofunctional ethylenically unsaturated compounds and the polyfunctional ethylenically unsaturated compounds will be exemplified later, and it is preferable to concurrently use these two types of these ethylenically unsaturated compounds.

The ethylenically unsaturated compound preferably used in the present invention has an ethylenically unsaturated bond at the molecular terminal thereof and between two carbon atoms adjacent to the molecular terminal. The number of the terminal ethylenically unsaturated group is at least one (monofunctional) in a single molecule and preferably is two or more (polyfunctional) in a single molecule. Such ethylenically unsaturated compounds are widely known in the industrial field of the related art and can be used in the present invention without particular limitation. The ethylenically unsaturated compound can be selected from among monomers having a molecular weight of less than 1,000, oligomers having a molecular weight of 1,000 to 5,000, or polymers having a molecular weight of greater than 5,000.

Examples of ethylenically unsaturated compounds include unsaturated carboxylic acids (such as acrylic acid, methacrylic acid, itaconic acid, crotonic acid, isocrotonic acid and maleic acid), and esters and amides thereof. Preferably esters of an unsaturated carboxylic acid and an aliphatic polyhydric alcoholic compound, or amides of an unsaturated carboxylic acid and an aliphatic polyvalent amine compound are used. Moreover, addition reaction products of unsaturated carboxylic acid esters or amides having a nucleophilic substituent such as a hydroxyl group, an amino group, or a mercapto group with monofunctional or polyfunctional isocyanates or epoxies, and dehydrating condensation reaction products with a monofunctional or polyfunctional carboxylic acid, etc. are also used favorably. Moreover, addition reaction products of unsaturated carboxylic acid esters or amides having an electrophilic substituent such as an isocyanato group or an epoxy group with monofunctional or polyfunctional alcohols, amines, or tiols, and substitution reaction products of unsaturated carboxylic acid esters or amides having a leaving group such as a halogen group or a tosyloxy group with monofunctional or polyfunctional alcohols, amines, or tiols are also favorable. Moreover, as another example, the use of compounds obtainable by replacing the unsaturated carboxylic acid with an unsaturated phosphonic acid, styrene, a vinyl ether compound or the like is also possible.

The ethylenically unsaturated compound includes monofunctional ethylenically unsaturated compounds and polyfunctional ethylenically unsaturated compounds. Examples of these compounds will be shown below. In the following description, the “ethylenically unsaturated compound” will be also referred to as a “monomer”.

Examples of ethylenically unsaturated compounds derived from unsaturated carbolylic acids include (meth)acrylic acid derivatives such as methyl(meth)acrylate, ethyl(meth)acrylate, n-butyl(meth)acrylate, 2-ethylhexyl(meth)acrylate, 2-hydroxyethyl(meth)acrylate, butoxyethyl(meth)acrylate, carbitol(meth)acrylate, cyclohexyl(meth)acrylate, benzyl(meth)acrylate, N-methylol(meth)acrylamide, and epoxy(meth)acrylate, as well as N-vinyl compounds such as N-vinylpyrrolidone and N-vinylcaprolactam, and allyl compounds such as allyl glycidyl ether, diallyl phthalate, and triallyl trimellitate.

Specific examples of ester monomers obtainable by reaction between an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include diethylene glycol dimethacrylate, tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, bis[p-(methacryloxyethoxy)phenyl]dimethylmethane and tricyclodecanedimethanol dimethacrylate.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetradicrotonate.

As isocrotonic acid esters there can be cited ethylene glycol diisocrotonate, pentaerythritol diisocrotonate, and sorbitol tetraisocrotonate.

As maleic acid esters there can be cited ethylene glycol dimaleate, triethylene glycol dimaleate, pentaerythritol dimaleate, and sorbitol tetramaleate.

As examples of other ester monomers, aliphatic alcohol-based esters described in JP-B-46-27926, JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture of two or more monomers.

Furthermore, specific examples of amide monomers including an amide of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based polymerizable compound produced by an addition reaction between an isocyanato-group and a hydroxy group is also preferable, and specific examples thereof include a vinylurethane compound comprising two or more polymerizable vinyl groups per molecule in which a hydroxy group-containing vinyl monomer represented by Formula (i) below is added to a polyisocyanate compound having two or more isocyanate groups per molecule described in JP-B-48-41708.

CH₂═C(R)COOCH₂CH(R′)OH (i)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of a polymerizable compound having an amino structure or a sulfide structure in the molecule described in JP-A-63-277653, JP-A-63-260909, and JP-A-1-105238, a resin composition having excellent curing properties can be obtainable.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

In view of increasing curing sensitivity, compounds containing a large number of ethylenically unsaturated groups in a single molecule are preferable, and in many cases, compounds having two or more functional groups are preferable. Moreover, in order to enhance the strength of the relief-forming layer, that is, the strength of the cured layer of the curable resin composition, compounds having three or more functional groups are more preferable. Furthermore, it is effective to use a method of regulating both the photosensitivity and strength by concurrently using compounds which differ from each other in terms of the number of functional group and the type of ethylenically unsaturated group (for example, acrylic acid ester, methacrylic acid ester, styrene-based compounds, and vinyl ether-based compounds).

The content of Component A is preferably 5 to 80 mass %, and more preferably 5 to 60 mass % with respect to the total solid mass content of the curable resin composition. Moreover, with regard to Component A, one type thereof may be used on its own, or two or more types thereof may be used concurrently.

When the monofunctional ethylenically unsaturated compound is used concurrently with the polyfunctional ethylenically unsaturated compound, the mixing ratio thereof is preferably 1:9 to 9:1, and more preferably 1:4 to 4:1. If the mixing ratio is within the above range, appropriate curing sensitivity and an appropriate degree of curing are obtainable.

### <(Component B) Polymerization Initiator>

The curable resin composition usable in the present invention comprises (Component B) a polymerization initiator. The polymerization initiator is not particularly limited, and compounds known to those skilled in the art can be usable without limitation. Preferable examples thereof include radical polymerization initiators. Among these, either of both of a thermopolymerization initiator and a photopolymerization initiator are usable, and a thermopolymerization initiator is preferably usable. Hereinafter, preferably usable thermopolymerization initiators will be explained in detail.

Examples of the thermal polymerization initiator include an aromatic ketone, an onium salt compound, an organic peroxide, a thio compound, a hexaarylbiimidazole compound, a ketoxime ester compound, a borate compound, an azinium compound, a metallocene compound, an active ester compound, a carbon-halogen bond-containing compound, and an azo-based compound.

In the present invention from the viewpoints of engraving sensitivity and good relief edge shape when applied to a relief-forming layer of a flexographic printing plate precursor, an organic peroxide and an azo-based compound are preferable and an organic peroxide is particularly preferable. Preferable examples of organic peroxides and azo-based compounds include the following compounds below.

### (c) Organic Peroxides

Preferable (c) organic peroxides as the radical polymerization initiator which can be usable in the present invention is preferably ether peroxide such as 3,3′,4,4′-tetra(tertiarybutylperoxycarbonyl)benzophenone, 3,3′,4,4′-tetra(tertiaryamylperoxycarbonyl)benzophenone, 3,3′,4,4′-tetra(tertiaryhexylperoxycarbonyl)benzophenone, 3,3′,4,4′-tetra(tertiaryoctylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-tertiarybutyldiperoxy isophthalate and tertiarybutyl peroxybenzoate, etc.

### (l) Azo-Based Compound

Preferable examples of azo-based compounds usable as the radical polymerization initiator in the present invention include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), 2,2′-dimethylazobisisobutyrate, 2,2′-azobis(2-methylpropionamidoxime), 2,2′-azobis[2-(2-imidazoline-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane), etc.

In the present invention, with regard to Component B, one type thereof may be usable on its own, or two or more types thereof may be usable concurrently.

The content of Component B is preferably 0.01 to 15 mass %, and more preferably 0.02 to 10 mass % with respect to the total mass of Component A. If the content of the polymerization initiator is controlled to be equal to or greater than 0.01 mass %, the addition of the polymerization initiator exerts an effect, and the curable resin composition is rapidly cured. If the content is controlled to be equal to or smaller than 15 mass %, there is no lack of other components, and printing durability sufficient for the precursor to be usable as a flexographic printing plate can be obtainable.

### <(Component C) Binder>

The curable resin composition usable in the present invention comprises (Component C) a binder. The binder may be either an elastomer or a plastomer.

In the present invention, the “plastomer” refers to a polymer which is easily fluidized and deformed by heating and can be solidified into a shape formed by deformation by cooling, as described in “Polymer Encyclopedia, New Edition” edited by The Society of Polymer Science, Japan (Japan, Asakura Publishing Co., Ltd., 1988). The “plastomer” is a contrasting term of an “elastomer” (a polymer having properties by which the polymer is deformed instantaneously by an external force when the external force is applied thereto and restores its original shape in a short time when the external force is removed). The plastomer does not undergo elastic deformation unlike the elastomer but easily undergoes plastic deformation.

Component C is preferably a plastomer at 20° C., and a binder polymer having a glass transition temperature (Tg) of no greater than 20° C. is preferable.

That is, generally, an elastomer is academically defined as a polymer having a glass transition temperature of no greater than 20° C. (room temperature) (ref. Kagaku Dai Jiten 2^{nd} edition (Science Dictionary), Foundation for Advancement of International Science, Maruzen, p. 154). Plastomer refers to a polymer which has a glass transition temperature of greater than room temperature. The upper limit for the glass transition temperature of the binder polymer is not limited, but is preferably no greater than 200° C. from the viewpoint of ease of handling, and is more preferably at least 25° C. but no greater than 120° C.

When a polymer having a glass transition temperature of room temperature (20° C.) or greater is used, the specific polymer is in a glass state at normal temperature. Because of this, compared with a case of the rubber state (elastomer), thermal molecular motion is suppressed. It is assumed that in laser engraving, in addition to the heat given by a laser during laser irradiation, heat generated by the function of a photothermal conversion agent is transmitted to the surrounding cross-linking structure, and this structure is thermally decomposed and disappears, thereby forming an engraved recess.

It is surmised that when a photothermal conversion agent is present in a state in which thermal molecular motion of a non-elastomer is suppressed, heat transfer to and thermal decomposition of the plastomer binder occur effectively. It is assumed that such an effect further enables to obtain high-definition flexographic printing plate having sharply defined shapes.

Hereinafter, specific examples of the plastomer binder at 20° C. and is preferably usable in the present invention will be described. As the polymer, which is a non-elastomeric binder preferably usable in the present invention, is such a polymer that is curable by heat or light exposure and in case of enhancing strength polymers having a hydroxyl group, an alkoxy group, hydrolysable silyl and silanol groups, and an ethylenically unsaturated group, and the like in a molecule are preferably usable.

The above reactive functional group may be present at any locations in polymer molecules, but is preferably present at the side chain of the branched polymer. Preferred examples of such a polymer include a vinyl copolymer (copolymer of a vinyl monomer such as polyvinyl alcohol and polyvinyl acetal, and a derivative thereof) and an acrylic resin (copolymer of an acryl-based monomer such as hydroxyethyl(meth)acrylate, and a derivative thereof).

A method of introducing the reactive functional group into the binder polymer is not particularly limited, and a method of addition-(co)polymerizing or addition-polycondensating a monomer having the reactive functional group and a method in which, after synthesizing a polymer having a group which can be introduced into the reactive functional group, the polymer is introduced into the reactive functional group by polymer reaction are included thereto.

As a binder polymer having a reactive group in the molecule, a binder polymer having a hydroxyl group is preferably used. A binder polymer having a hydroxyl group will be explained below.

The hydroxyl group-containing binder polymer (hereinafter, also referred to as a “specific polymer”) is preferably insoluble in water but soluble in an alcohol having 1 to 4 carbon atoms. Preferable examples thereof include polyvinyl acetal and derivatives thereof, acrylic resins having a hydroxyl group in a side chain thereof, novolac resins, epoxy resins having a hydroxyl group in a side chain thereof. These will be explained in detail below.

### (1) Polyvinyl Acetal and Derivatives Thereof

Polyvinyl acetal usable as a non-elastomer binder is a compound obtainable by converting polyvinyl alcohol (obtained by saponifying polyvinyl acetate) into a cyclic acetal. A polyvinyl acetal derivative is a polymer that polyvinyl acetal above is modified, or a polyvinyl acetal having another copolymerization component.

The acetal content in the polyvinyl acetal (mole % of vinyl alcohol units converted into acetal with the total number of moles of vinyl acetate monomer starting material as 100%) is preferably 30 to 90%, more preferably 50 to 85%, and particularly preferably 55 to 78%.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal derivative may further have another copolymerization unit.

Examples of the polyvinyl acetal include polyvinyl butyral, polyvinyl propylal, polyvinyl ethylal, and polyvinyl methylal. Among them, polyvinyl butyral derivative (PVB) is preferable.

Polyvinyl butyral is a polymer obtainable by a reaction between polyvinyl alcohol and butyl aldehyde. A polyvinyl butyral derivative may be usable.

Examples of the polyvinyl butyral derivatives include an acid-modified PVB in which at least some of the hydroxy groups of the hydroxyethylene units are modified with an acid group such as a carboxy group, a modified PVB in which some of the hydroxy groups are modified with a (meth)acryloyl group, a modified PVB in which at least some of the hydroxy groups are modified with an amino group, and a modified PVB in which at least some of the hydroxy groups have introduced thereinto ethylene glycol, propylene glycol, or a multimer thereof.

From the viewpoint of a balance being achieved between engraving sensitivity and film formation properties, the molecular weight of the polyvinyl acetal is preferably 5,000 to 800,000 as the weight-average molecular weight, more preferably 8,000 to 500,000 and, from the viewpoint of improvement of rinsing properties for engraving residue, particularly preferably 50,000 to 300,000.

Hereinafter, polyvinyl butyral (PVB) and derivatives thereof are cited for explanation as particularly preferable examples of polyvinyl acetal, but are not limited to these.

Polyvinyl butyral has a structure as shown below, and is constituted while including these structural units.

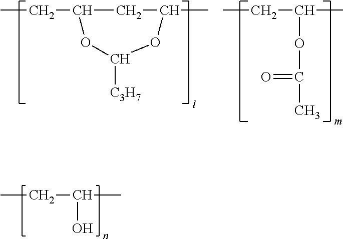

In the above formula, l, m, and n denote the content (mol %) of the respective repeating units in polyvinyl butyral, and the relationship l+m+n=100 is satisfied. The butyral content in the polyvinyl butyral and the derivative thereof (value of l in the formula above) is preferably 30 to 90 mole %, more preferably 50 to 85 mole %, and particularly preferably 55 to 78 mole %.

From the viewpoint of a balanced printing sensitivity and film-forming properties, the weight-average molecular weight of the polyvinyl butyral and the derivatives thereof is preferably 50,000 to 800,000, more preferably 8,000 to 500,000 and particularly preferably 50,000 to 300,000 from the viewpoint of increased rinsing properties of engraved residue.

The PVB derivative is also available as a commercial product, and preferred examples thereof include, from the viewpoint of alcohol dissolving capability (particularly, ethanol), “S-REC B” series and “S-REC K (KS)” series manufactured by SEKISUI CHEMICAL CO., LTD. and “DENKA BUTYRAL” manufactured by DENKI KAGAKU KOGYO KABUSHIKI KAISHA. From the viewpoint of alcohol dissolving capability (particularly, ethanol), “S-REC B” series manufactured by SEKISUI CHEMICAL CO., LTD. and “DENKA BUTYRAL” manufactured by DENKI KAGAKU KOGYO KABUSHIKI KAISHA are more preferable. Among these, particularly preferable commercial products are shown below along with the values l, m, and n in the above formulae and the molecular weight. Examples of “S-REC B” series manufactured by SEKISUI CHEMICAL CO., LTD. include “BL-1” (l=61, m=3, n=36, weight-average molecular weight: 19,000), “BL-1H” (l=67, m=3, n=30, weight-average molecular weight: 20,000), “BL-2” (l=61, m=3, n=36, weight-average molecular weight: about 27,000), “BL-5” (l=75, m=4, n=21, weight-average molecular weight: 32,000), “BL-S” (l=74, m=4, n=22, weight-average molecular weight: 23,000), “BM-S” (l=73, m=5, n=22, weight-average molecular weight: 53,000), and “BH-S” (l=73, m=5, n=22, weight-average molecular weight: 66,000), and examples of “DENKA BUTYRAL” manufactured by DENKI KAGAKU KOGYO include “#3000-1” (l=71, m=1, n=28, weight-average molecular weight: 74,000), “#3000-2” (l=71, m=1, n=28, weight-average molecular weight: 90,000), “#3000-4” (l=71, m=1, n=28, weight-average molecular weight: 117,000), “#4000-2” (l=71, m=1, n=28, weight-average molecular weight: 152,000), “#6000-C” (l=64, m=1, n=35, weight-average molecular weight: 308,000), “#6000-EP” (l=56, m=15, n=29, weight-average molecular weight: 381,000), “#6000-CS” (l=74, m=1, n=25, weight-average molecular weight: 322,000), and “#6000-AS” (l=73, m=1, n=26, weight-average molecular weight: 242,000). Also preferable is Mowital series of KURARAY CO., LTD. such as “B 16 H” (m=1 to 4, n=18 to 24), “B 20 H” (m=1 to 4, n=18 to 21), “B 30 T” (m=1 to 4, n=24 to 27), “B 30 H” (m=1 to 4, n=18 to 21), “B 30 HH” (m=1 to 4, n=11 to 14), “B 45 M” (m=1 to 4, n=21 to 24), “B 45 H” (m=1 to 4, n=18 to 21), “B 60 T” (m=1 to 4, n=24 to 27), “B 60 H” (m=1 to 4, n=18 to 21), “B 60 HH” (m=1 to 4, n=12 to 16) and “B 75 H” (m=1 to 4, n=18 to 21)

When the relief-forming layer is formed by using the PVB derivative as a specific polymer, a method of casting and drying a solution in which the binder is dissolved in a solvent is preferable from the viewpoint of smoothness of the film surface.

### (2) Acrylic Resin

As an acrylic resin usable as a non-elastomer binder, an acrylic resin may be preferably used which can be synthesized from an acrylic monomer having a hydroxy group in the molecule.

Preferable examples of the acrylic monomer usable for producing an acrylic resin having a hydroxy group include a (meth)acrylic acid ester, a crotonic acid ester, or a (meth)acrylamide that has a hydroxy group in the molecule. Specific examples of such a monomer include 2-hydroxyethyl(meth)acrylate, 2-hydroxypropyl(meth)acrylate, and 4-hydroxybutyl(meth)acrylate.

In the present invention ‘(meth)acryl’ means either one or both of ‘acryl’ and/or ‘methacryl’ and ‘(meth)acrylate’ means either one or both of ‘acrylate’ or ‘methacrylate.’

The acrylic resin may be constituted from a known acrylic comonomer other than the acrylic monomer having a hydroxy group explained above.

As the known (meth)acrylic comonomer, the (meth)acrylic monomer can be cited, and specific examples thereof include methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-hexyl(meth)acrylate, lauryl(meth)acrylate, 2-ethylhexyl(meth)acrylate, acetoxyethyl(meth)acrylate, phenyl(meth)acrylate, 2-methoxyethyl(meth)acrylate, 2-ethoxyethyl(meth)acrylate, 2-(2-methoxyethoxyl)ethyl(meth)acrylate, cyclohexyl(meth)acrylate, t-butylcyclohexyl(meth)acrylate, benzyl(meth)acrylate, diethylene glycol monomethyl ether(meth)acrylate, diethylene glycol monoethyl ether(meth)acrylate, diethylene glycol monophenyl ether(meth)acrylate, triethylene glycol monomethyl ether(meth)acrylate, triethylene glycol monoethyl ether(meth)acrylate, dipropylene glycol monomethyl ether(meth)acrylate, polyethylene glycol monomethyl ether(meth)acrylate, polypropylene glycol monomethyl ether(meth)acrylate, the monomethyl ether(meth)acrylate of a copolymer of ethylene glycol and propylene glycol, N,N-dimethylaminoethyl(meth)acrylate, N,N-diethylaminoethyl(meth)acrylate, and N,N-dimethylaminopropyl(meth)acrylate.

Furthermore, a modified acrylic resin formed with a urethane group- or urea group-containing acrylic monomer may preferably be usable.

Among these, from the viewpoint of aqueous ink resistance, an alkyl(meth)acrylate such as lauryl(meth)acrylate and an aliphatic cyclic structure-containing (meth)acrylate such as t-butylcyclohexyl(meth)acrylate are more preferable.

### (3) A Novolac Resin

Furthermore, as the non-elastomer binder, a novolac resin is preferably usable, this being a resin formed by condensation of a phenol and an aldehyde under acidic conditions.

Preferred examples of the novolac resin include a novolac resin obtainable from phenol and formaldehyde, a novolac resin obtainable from m-cresol and formaldehyde, a novolac resin obtainable from p-cresol and formaldehyde, a novolac resin obtainable from o-cresol and formaldehyde, a novolac resin obtainable from octylphenol and formaldehyde, a novolac resin obtainable from mixed m-/p-cresol and formaldehyde, and a novolac resin between a mixture of phenol/cresol (any of m-, p-, o- or m-/p-, m-/o-, o-/p-mixtures) and formaldehyde.

With regard to these novolac resins, those having a weight-average molecular weight of 800 to 200,000 and a number-average molecular weight of 400 to 60,000 are preferable.

### <(4) Epoxy Resin Having Hydroxy Group in a Side Chain>

An epoxy resin having a hydroxy group in a side chain may be usable as a non-elastomer binder. Preferred examples of the epoxy resin include an epoxy resin formed by polymerization, as a starting material monomer, of an addition-product of bisphenol A and epichlorohydrin. The epoxy resin preferably has a weight-average molecular weight of at least 800 but no greater than 200,000, and a number-average molecular weight of at least 400 but no greater than 60,000.

Among non-elastomer binders, polyvinyl butyral derivatives are more preferable from the viewpoint of rinsing properties and printing durability when the polymer is formed into the relief-forming layer.

The content of the hydroxyl groups contained in the nonelastomer binder usable in the present invention is preferably 0.1 to 15 mmol/g, and more preferably 0.5 to 7 mmol/g.

For the thermosetting resin composition usable in the present invention, in addition to the non-elastomeric binder, known polymer not included in the non-elastomeric binder may be usable. When such a polymer is used, one type thereof may be used on its own, or a plurality thereof may be used concurrently. Hereinafter, such a polymer will be also referred to as a general polymer.

The general polymer constitutes the main component included in the flexographic printing plate precursor for laser engraving, in addition to the above-described nonelastomer binder, and therefore, one kind or two or more kinds of the general polymer compounds that are not included in the non-elastomer binder can be appropriately selected and usable. Particularly, when a flexographic printing plate precursor is used as a printing plate precursor, it is necessary to select a binder polymer while taking into consideration various performances such as laser engraving properties, ink acceptability, and engraving residue dispersibility.

The general polymer may be selected from polystyrene resin, polyester resin, polyamide resin, polyureapolyamideimide resin, polyurethane resin, polysulfone resin, polyether sulfone resin, polyethersulfone, polyimide resin, polycarbonate resin, hydroxyethylene unit-containing hydrophilic polymer, acrylic resin, acetal resin, polycarbonate resin, rubber, thermoplastic elastomer, etc.

For example, from the viewpoint of the laser engraving sensitivity, polymers having a partial structure capable of being thermally decomposed by exposure or heating are preferable. Examples of such polymers preferably include those described in JP-A-2008-163081, paragraph 0038.

With regard to Component C in the composition for laser engraving usable in the present invention, only one type may be used or two or more types may be used in combination.

The content of Component C contained in the composition for laser engraving of the present invention is, from the viewpoint of a balance being obtainable between shape retention, water resistance, and engraving sensitivity of a coated film, preferably 2 to 95 mass % of the total solids content of the composition for laser engraving of the present invention, more preferably 5 to 80 mass %, and particularly preferably 10 to 60 mass %.

As (Component C) a binder, (Component C-1) a polyisoprene which is a plastomer at 20° C. and does not have an ethylenically unsaturated group at the terminal of a main chain thereof, (Component C-2) a polybutadiene which is a plastomer at 20° C. and does not contain an ethylenically unsaturated group at the terminal of a main chain thereof, or (Component C-3) an unsaturated polyester urethane which is a plastomer at 20° C. and has an ethylenically unsaturated group in the inside of a main chain thereof but does not have an ethylenically unsaturated group at the terminal of a main chain thereof, which will be described later, are also preferably usable.

(Component C-1) Polyisoprene that is a Plastomer at 20° C. And does not have an Ethylenically Unsaturated Group at the Ends of the Main Chain

According to the present invention, (Component C-1) a polyisoprene that is a plastomer at 20° C. and does not have an ethylenically unsaturated group at the terminals of the main chain can be used as Component C. When a binder having an ethylenically unsaturated group at the terminal of the main chain, the mobility of the main chain, after crosslinking, movement of the main chain is suppressed, and as a result, the glass transition temperature increases. Therefore, there is a concern that the rubber elasticity that is needed for flexographic printing may be impaired and satisfactory ink transferability may not be obtained. When an ethylenically unsaturated group is located in the interior of the main chain, it is expected that a decrease in the mobility is not large and thus the glass transition temperature does not tend to increase.

Component C-1 may be a polymer having a main chain which contains isoprene monomer unit, and a terminal-modified polyisoprene or a hydrogenated polyisoprene is also included. Examples of Component C-1 include polyisoprene, partially hydrogenated polyisoprene and polyisoprene polyol, and polyisoprene and polyisoprene polyol are preferred, and polyisoprene polyol is particularly preferred. Polyisoprene polyol is preferred in view of the compatibility with other components.

Furthermore, commercially available polyisoprene and polyisoprene polyol can also be usable as Component C-1, and the examples thereof include KURAPRENE LIR series (manufactured by Kuraray Co., Ltd.).

Isoprene is known to be polymerized by 1,2-addition, 3,4-addition, or 1,4-addition depending on the catalyst or the reaction conditions, and in the present invention, any isoprene that is polymerized by the additions described above may be employed. Meanwhile, in the 1,2-addition and the 3,4-addition, the polyisoprene has an ethylenically unsaturated group at the side chain end, but does not have an ethylenically unsaturated group at the main chain terminal, and in the 1,4-addition (cis- and trans-), the polyisoprene does not have an ethylenically unsaturated group at the main chain terminal and an ethylenically unsaturated group is formed between the second carbon atom and the third carbon atom from the end in the monomer unit.

Among these, from the viewpoint that the polymer needs to be a plastomer at 20° C., it is preferable that a 1,4-addition product be a main component; it is more preferable that cis-1,4-polyisoprene be a main component; and it is even more preferable that cis-1,4-polyisoprene constitutes 80% or more, and more preferably 90% or more.

The molecular weight of Component C-1 is not particularly limited so long as it is a plastomer at 20° C., but from the viewpoint of the tensile strength of the film, the weight-average molecular weight thereof is preferably 5,000 to 500,000, more preferably 8,000 to 300,000, and even more preferably 10,000 to 200,000.

(Component C-2) Polybutadiene that is a Plastomer at 20° C. And does not Contain an Ethylenically Unsaturated Group at the Terminals of the Main Chain

According to the present invention, (Component C-2) a polybutadiene that is a plastomer at 20° C. and does not have an ethylenically unsaturated group at the terminals of the main chain can be used as Component C. When Component C-2 has an ethylenically unsaturated group at the terminals of the main chain, the mobility of the main chain after crosslinking is suppressed, and as a result, the glass transition temperature increases. Therefore, there is a concern that the rubber elasticity that is needed for flexographic printing may be impaired and satisfactory ink transferability may not be obtained. If Component C-2 has an ethylenically unsaturated group in the interior of the main chain, it is expected that a decrease in the mobility is not large as it is located in the the main chain terminals, and thus the glass transition temperature does not tend to increase.

Component C-2 may be a polymer having a main chain which contains butadiene as a monomer unit, and a terminal-modified polybutadiene or a hydrogenated polybutadiene is included in Component C-2. Examples of Component C-2 include polybutadiene, partially hydrogenated polybutadiene and polybutadiene polyol, and polybutadiene and polybutadiene polyol are preferred, while polybutadiene polyol is particularly preferred. Polybutadiene polyol is preferred from the viewpoint of the compatibility with other components.

Furthermore, commercially available polybutadiene and polybutadiene polyol can also be usable as Component C-2, and the examples thereof include KURAPRENE LBR series (manufactured by Kuraray Co., Ltd.) and Poly bd (manufactured by Idemitsu Kosan Co., Ltd.).

Butadiene is known to be polymerized by 1,2-addition or 1,4-addition depending on the catalyst or the reaction conditions, and in the present invention, polybutadiene polymerized by any of the additions described above may be employed. Meanwhile, in the 1,2-addition, the polybutadiene has an ethylenically unsaturated group at the side chain end, but does not have an ethylenically unsaturated group at the main chain end and in the 1,4-addition (cis- and trans-), the polybutadiene does not have an ethylenically unsaturated group at the main chain end, and an ethylenically unsaturated group is formed between the second carbon atom and the third carbon atom from the end.

Among these, from the viewpoint that the polymer needs to be a plastomer at 20° C., it is preferable that a 1,4-addition product be a main component, and it is more preferable that trans-1,4-polybutadiene be a main component.

The molecular weight of Component C-2 is not particularly limited so long as it is a plastomer at 20° C., but from the viewpoint of the tensile strength of the film, the weight-average molecular weight thereof is preferably 1,500 to 500,000, more preferably 2,000 to 300,000, and even more preferably 2,500 to 200,000.

(Component C-3) Unsaturated Polyester Urethane that is a Plastomer at 20° C., has an Ethylenically Unsaturated Group in the Interior of the Main Chain, and does not have an Ethylenically Unsaturated Group at the Ends of the Main Chain

According to the present invention, (Component C-3) an unsaturated polyester urethane that is a plastomer at 20° C., has an ethylenically unsaturated group in the interior of the main chain, and does not have an ethylenically unsaturated group at the ends of the main chain, can be usable as Component C. When Component C-3 has an ethylenically unsaturated group at the ends of the main chain, the mobility of the main chain after crosslinking is suppressed, and as a result, the glass transition temperature increases. Therefore, there is a concern that the rubber elasticity that is needed for flexographic printing may be impaired and satisfactory ink transferability may not be obtained. If Component C-3 has an ethylenically unsaturated group in the interior of the main chain, it is expected that a decrease in the mobility is not large as it is in the case of the main chain ends, and thus the glass transition temperature does not tend to increase.

Component C-3 is obtainable by allowing an unsaturated polyester polyol to react with various polyisocyanate compounds. Furthermore, the unsaturated polyester polyol is obtainable by a polycondensation reaction between a polyvalent carboxylic acid component including an unsaturated polycarboxylic acid and a polyhydric alcohol component, and in the process, when a slight excess amount of the polyalcohol component is usable, the ends of the product can be modified with hydroxyl groups.

The polycarboxylic acid component of the unsaturated polyester polyol is preferably a dicarboxylic acid, and the examples thereof include unsaturated dicarboxylic acid, and aromatic, alicyclic or aliphatic dicarboxylic acids.

Specific examples of the unsaturated dicarboxylic acid include α,β-unsaturated dicarboxylic acids such as maleic acid, maleic anhydride, fumaric acid, and itaconic acid.

Specific examples of the aromatic dicarboxylic acid include phthalic acid, isophthalic acid, phthalic anhydride, terephthalic acid, 2,6-naphthalenedicarboxylic acid, 2,7-naphthalenedicarboxylic acid, 2,3-naphthalenedicarboxylic acid, 2,3-naphthalenedicarboxylic anhydride, and 4,4′-bisphenyldicarboxylic acid. Specific examples of the alicyclic dicarboxylic acid include tetrahydrophthalic anhydride, tetrahydrophthalic acid, hexahydrophthalic acid, hexahydrophthalic anhydride, hexahydroterephthalic acid, and hexahydroisophthalic acid. Specific examples of the aliphatic carboxylic acid include succinic acid, adipic acid, sebacic acid, malonic acid, glutaric acid, and sebacic acid.

Furthermore, the dialkyl esters thereof may also be usable.

The polyhydric alcohol component of the unsaturated polyester polyol is preferably a diol, and the examples thereof include alkylenediols and polyoxyalkylene glycols.

Specific examples of the alkylenediol include ethylene glycol, propylene glycol, trimethylene glycol, tetramethylene glycol, hexamethylene glycol, and neopentyl glycol. Specific examples of the polyoxyalkylene glycol include diethylene glycol, triethylene glycol, polyoxypropylene glycol, and polyoxytetramethylene glycol.

In the unsaturated polyester, in order to enhance heat resistance of the flexographic printing plate precursor, a double bond is introduced into a portion of the polyvalent carboxylic acid component by using an unsaturated polyvalent carboxylic acid. The double bond concentration is preferably 10⁻⁴ mol/g to 10⁻² mol/g relative to the amount of Component C-3 thus obtained. If the double bond concentration is 10⁻⁴ mol/g or greater, deformation of the relief is suppressed, and if the double bond concentration is 10⁻² mol/g or less, excellent strength is obtainable.

In the present invention, as the isocyanate usable to obtain Component C-3, a polyvalent isocyanate compound having two or more isocyanate groups in the molecule is employed. Specific examples of diisocyanate include 2,6-tolylene diisocyanate, 2,4-tolylene diisocyanate, p-xylylene diisocyanate, m-xylylene diisocyanate, hydrated p-xylylene diisocyanate, hydrated m-xylylene diisocyanate, isophorone diisocyanate, 1,6-hexamethylene diisocyanate, trimethylhexamethylene diisocyanate, lysine diisocyanate, 1,3-bis(isocyanatomethyl)cyclohexane, norbornane diisocyanate methyl, dicyclohexylmethane diisocyanate, 4,4′-diphenylmethane diisocyanate, naphthalene diisocyanate, p-phenylene diisocyanate, diphenylmethane diisocyanate (MDI), and hydrogenated diphenylmethane diisocyanate.

Furthermore, the adducts or the oligomers of the various isocyanates described above can also be usable. The examples thereof include adducts of tolylene diisocyanate and tolylene diisocyanate trimer. Furthermore, biuret type and isocyanurate type polyisocyanates obtainable by a co-reaction with water can also be usable.

Regarding the isocyanate compounds, one kind may be used alone, or two or more kinds may be used in combination.

As Component C-3, commercially available polyester urethanes may be usable, and the examples thereof include VYLON series (manufactured by Toyoboseki Co., Ltd.).

The molecular weight of Component C-3 is not particularly limited so long as Component A-3 is a plastomer at 20° C., but from the viewpoint of the tensile strength of the film, the weight-average molecular weight thereof is preferably 5,000 to 500,000, more preferably 8,000 to 300,000, and even more preferably 10,000 to 200,000.

Component A may be at least one selected from the group consisting of Component C-1 to Component C-3, and two or more may also be used in combination.

Furthermore, Component C is preferably Component C-1 or Component C-3, and more preferably Component C-3.

As the thermoplastic resin, various commercially available thermoplastic elastomers described below can be used.

As styrene-based thermoplastic elastomers, SBS (styrene-butadiene-styrene copolymer), SIS (styrene-isoprene copolymer), SEBS (styrene-ethylene-butylene-styrene copolymer), and the like can be used. Specific examples thereof include “Cariflex” and “KratonG” manufactured by Shell Corporation, “Tufprene” manufactured by Asahi Kasei Chemicals Corporation, “Solprene” manufactured by Nippon Elastomer Corporation, “Sumitomo TPE” manufactured by SUMITOMO CHEMICAL Co., Ltd., and “Laban” manufactured by Mitsubishi Chemical Corporation.

Specific examples of olefin-based thermoplastic elastomers include “Santoprene” manufactured by Monsanto Company, “Fcrroflex” manufactured by Ferra, and “Milastomer” manufactured by Mitsui Chemicals, Inc.

Moreover, specific examples of urethane-based thermoplastic elastomers include “Pandex” manufactured by DIC Corporation, “Elastran” manufactured by Nippon Miractran Co., Ltd., “Paraprene” manufactured by NIPPON POLYURETHANE INDUSTRY CO., LTD., and “Desmopan” manufactured by Sumitomo Bayer Co., Ltd.

As ethylene-based thermoplastic elastomers, EVA (ethylene-vinyl acetate copolymer), EEA (ethylene-acrylic acid copolymer), and the like can be usable.

In addition, as thermoplastic elastomers, RB (1,2-polybutadiene manufactured by JSR Corporation), chlorinated polyethylene, and the like can also be usable.

The content of Component C in the resin composition is preferably 5 mass % to 90 mass %, more preferably 15 mass % to 85 mass %, and even more preferably 30 mass % to 80 mass %, relative to the total weight of the solids content. If the content of Component C is in the range described above, a relief layer having excellent rinsing properties of engraving residue and excellent ink transferability is obtainable, which is preferable.

The resin composition for laser engraving of the present invention may comprise a binder polymer (resin component) other than Component C-1 to C-3. The examples of the binder polymer other than above-described include the non-elastomers described in JP-A-2011-136455, and the unsaturated group-containing polymers described in JP-A-2010-208326.

The curable resin composition for laser engraving of the present invention preferably comprises above-mentioned binder polymer as a main component, and if the resin composition comprises other binder polymers, the content thereof relative to the total mass of Component C is preferably 60 mass % or greater, more preferably 70 mass % or greater, and even more preferably 80 mass % or greater. Meanwhile, the upper limit of the content of thereof is not particularly limited, and is especially preferably 100 wt %, that is, it is especially preferable that the resin composition comprises no other binder polymers other than Component C. However, if the resin composition comprises other binder polymers, the upper limit thereof is preferably 99 wt % or less, more preferably 97 wt % or less, and even more preferably 95 wt % or less.

### <(Component D) Photothermal Conversion Agent>

The curable resin composition usable in the present invention can preferably comprise (Component D) a photothermal conversion agent, in addition to Component A to Component C. Component D preferably absorbs a wavelength of 700 nm to 1,300 nm. It is considered that if Component D has such properties, it may generate heat by absorbing the laser light of the wavelength band, accelerate pyrolysis of the relief-forming layer of the flexographic printing plate precursor of the present invention, hence sensitivity in laser engraving may be improved. Component D is preferably usable as an infrared absorbent when it is usable for laser engraving in which a laser (a YAG laser, a semiconductor laser, a fiber laser, a surface emitting laser, or the like) of 700 nm to 1,300 nm is usable as a light source.

Specific compounds as Component D are not particularly limited as long as they have the absorption maximum at a wavelength of 700 nm to 1,300 nm, and preferable examples thereof include dyes or pigments.

As the dyes, there can be usable commercially available products or other known dyes disclosed in, for example, Senryo Binran (Dye Handbook), edited by The Society of Synthetic Organic Chemistry, Japan, published in 1970.

Specific examples thereof include azo dyes, metal complex salt azo dyes, pyrazolone azo dyes, naphthoquinone dyes, anthraquinone dyes, phthalocyanine dyes, carbonium dyes, diimonium compounds, quinonimine dyes, methine dyes, cyanine dyes, squarylium dyes, pyrylium salts, and metal thiolate complexes, and the like.

Preferable examples of the dyes include cyanine dyes disclosed in JP-A-58-125246, JP-A-59-84356, JP-A-59-202829, JP-A-60-78787 and the like; methine dyes disclosed in JP-A-58-173696, JP-A-58-181690, JP-A-58-194595 and the like; naphthoquinone dyes disclosed in JP-A-58-112793, JP-A-58-224793, JP-A-59-48187, J P-A-59-73996, J P-A-60-52940, J P-A-60-63744 and the like; squarylium dyes disclosed in JP-A-58-112792; and cyanine dyes disclosed in U.K. Patent No. 434,875 and the like.

Furthermore, near infrared ray absorption sensitizers disclosed in U.S. Pat. No. 5,156,938 may also be suitably usable, and substituted arylbenzo(thio)pyrylium salts disclosed in U.S. Pat. No. 3,881,924, trimethine thiapyrylium salts disclosed in JP-A-57-142645 (U.S. Pat. No. 4,327,169), pyrylium type compounds disclosed in JP-A-58-181051, JP-A-58-220143, JP-A-59-41363, J P-A-59-84248, J P-A-59-84249, JP-A-59-146063 and J P-A-59-146061, cyanine dyes disclosed in JP-A-59-216146, pentamethine thiopyrylium salts disclosed in U.S. Pat. No. 4,283,475, and pyrylium compounds disclosed in JP-B-5-13514 and JP-B-5-19702 are preferably usable. Other preferable examples of the dyes include near infrared ray absorption dyes represented by Formula (I) or (II) described in U.S. Pat. No. 4,756,993.

Also, other preferred examples of Component D usable in the present invention include specific indolenine cyanine dyes described in JP-A-2002-278057.

Among these dyes, preferred are a cyanine dye, a squarylium dye, a pyrylium salt, a nickel thiolate complex and an indolenine cyanine dye, more preferred are a cyanine dye and an indolenine cyanine dye.

Specific examples of the cyanine dye which can be suitably usable in the present invention include those described in JP-A-2001-133969 (paragraphs no. 0017 to 0019), JP-A-2002-40638 (paragraphs no. 0012 to 0038), and JP-A-2002-23360 (paragraphs no. 0012 to 0023).

The dye represented by the following formula (d) or (e) is preferred in view of light-to-heat conversion.

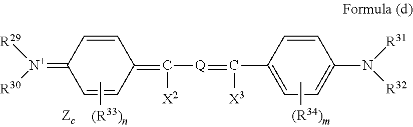

In formula (d), R²⁹ to R³² each independently represents a hydrogen atom, an alkyl group or an aryl group. R³³ and R³⁴ each independently represents an alkyl group, a substituted oxy group or a halogen atom. n and m each independently represents an integer of 0 to 4. The pair of R²⁹ and R³⁰ or the pair of R³¹ and R³² may combine with each other to form a ring. Also, R²⁹ and/or R³⁰ may combine with R³³ to form a ring, or R³¹ and/or R³² may combine with R³⁴ to form a ring. In the case where a plurality of R³³s or R³⁴s are present, R³³s or R³⁴s may combine with each other to form a ring. X² and X³ each independently represents a hydrogen atom, an alkyl group or an aryl group, provided that at least one of X² and X³ represents a hydrogen atom or an alkyl group. Q represents a trimethine group which may have a substituent or a pentamethine group which may have a substituent or may form a ring structure together with a divalent organic group. Zc⁻ represents a counter anion. However, Zc⁻ is not necessary when the coloring matter represented by formula (d) has an anionic substituent in its structure and neutralization of charge is not needed. In view of storage stability of the coating solution for the relief-forming layer, Zc⁻ is preferably a halogen ion, a perchlorate ion, a tetrafluoroborate ion, a hexafluorophosphate ion or a sulfonate ion, particularly preferably a perchlorate ion, a hexafluorophosphate ion or an arylsulfonate ion.

Specific examples of the dye represented by formula (d) which can be suitably usable in the present invention include those shown below.

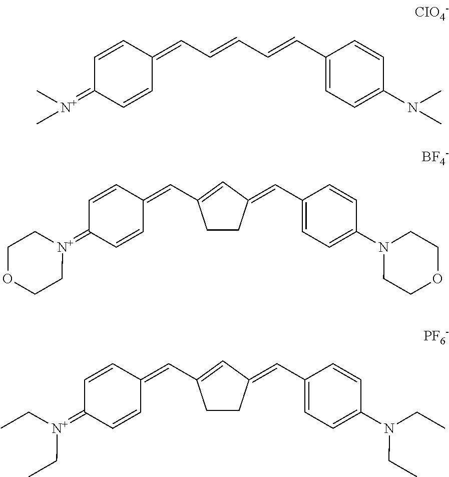

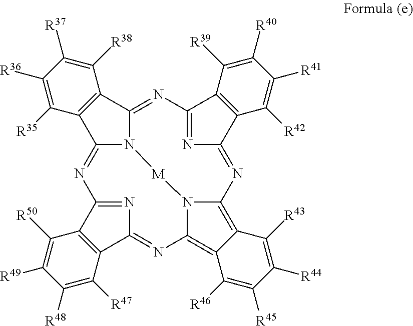

In formula (e), R³⁵ to R⁵⁰ each independently represents a hydrogen atom, a halogen atom, a cyano group, an alkyl group, an aryl group, an alkenyl group, an alkynyl group, a hydroxy group, a carbonyl group, a thio group, a sulfonyl group, a sulfinyl group, an oxy group, an amino group or an onium salt structure. These groups each may have a substituent when a substituent can be introduced thereinto. M represents two hydrogen atoms, a metal atom, a halometal group or an oxymetal group, and examples of the metal atom contained therein include atoms of Groups 1, 2, 13 and 14 of the periodic table, transition metals of first, second and third periods, and lanthanoid element. Among these, copper, magnesium, iron, zinc, cobalt, aluminum, titanium and vanadium are preferred.

Specific examples of the dye represented by formula (e) which can be suitably usable in the present invention include those shown below.

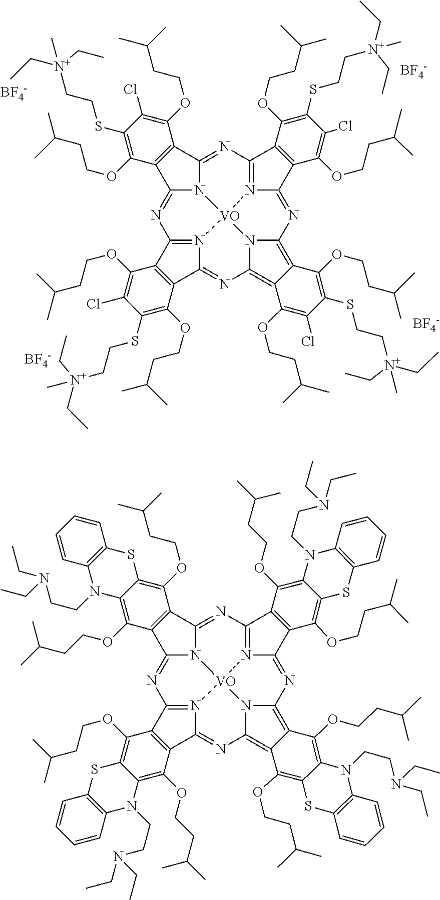

With regard to the photothermal conversion agent usable in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984).

Examples of the type of pigment include a black pigment, a yellow pigment, an orange pigment, a brown pigment, a red pigment, a purple pigment, a blue pigment, a green pigment, a fluorescent pigment, a metal powder pigment and, in addition, polymer-binding dyes. Specifically, an insoluble azo pigment, an azo lake pigment, a condensed azo pigment, a chelate azo pigment, a phthalocyanine type pigment, an anthraquinone type pigment, perylene and perinone type pigments, a thioindigo type pigment, a quinacridone type pigment, a dioxazine type pigment, an isoindolinone type pigment, a quinophthalone type pigment, a dye lake pigment, an azine pigment, a nitroso pigment, a nitro pigment, a natural pigment, a fluorescent pigment, an inorganic pigment, carbon black, etc. may be used. Among these pigments, carbon black is preferable.

These pigments may be usable with or without a surface treatment. The methods of the surface treatment include methods of coating a resin or wax onto the surface, applying a surfactant, binding a reactive substance (e.g., a silane coupling agent, epoxy compound, polyisocyanate, and the like) to the pigment surface, and the like. The above mentioned surface treatment methods are described in Kinzoku Sekken No Seishitsu To Ohyo (Properties and Applications of Metallic Soaps), published by Saiwai Shobo; Insatsu Inki Gijutsu (Printing Ink Technologies), published by CMC Publishing Co., Ltd. (1984); and Saishin Ganryo Ohyo Gijutsu (Current Pigment Application Technologies), published by CMC Publishing Co., Ltd. (1986).

Furthermore, when the photothermal conversion agent and the binder polymer are usable in a combination (condition) such that the thermal degradation temperature of the photothermal conversion agent is equal to or higher than the thermal degradation temperature of the binder polymer, the engraving sensitivity tends to increase, which is preferable.

Specific examples of the photothermal conversion agent usable in the present invention include cyanine-based dyes such as heptamethinecyanine dyes; oxonol-based dyes such as pentamethineoxonol dyes; indolium-based dyes, benzindolium-based dyes, benzothiazolium-based dyes, quinolinium-based dyes, and phthalide compounds that have been reacted with color developing agents. Not all the cyanine-based dyes have the light absorption characteristics described above. The light absorption characteristics vary to a very large extent depending on the type of a substituent and the position thereof in the molecule, the number of conjugated bonds, the type of the counterion, the environment in which the dye molecules exist, and the like.

Furthermore, laser dyes, supersaturation absorbing dyes, and near-infrared absorbing dyes that are commonly marketed can also be usable. Examples of the laser dyes include “ADS740PP”, “ADS745HT”, “ADS760MP”, “ADS740WS”, “ADS765WS”, “ADS745HO”, “ADS790NH”, and “ADS800NH” (all trade names) manufactured by American Dye Source, Inc. (Canada); and “NK-3555”, “NK-3509”, and “NK-3519” (all trade names) manufactured by Hayashibara Biochemical Laboratories, Inc. Also, examples of the near-infrared absorbing dyes include “ADS775MI”, “ADS775MP”, “ADS775HI”, “ADS775PI”, “ADS775PP”, “ADS780MT”, “ADS780BP”, “ADS793EI”, “ADS798MI”, “ADS798MP”, “ADS800AT”, “ADS805PI”, “ADS805PP”, “ADS805PA”, “ADS805PF”, “ADS812MI”, “ADS815EI”, “ADS818HI”, “ADS818HT”, “ADS822MT”, “ADS830AT”, “ADS838MT”, “ADS840MT”, “ADS845BI”, “ADS905AM”, “ADS956BI”, “ADS1040T”, “ADS1040P”, “ADS1045P”, “ADS1050P”, “ADS1060A”, “ADS1065A”, “ADS1065P”, “ADS1100T”, “ADS1120F”, “ADS1120P”, “ADS780WS”, “ADS785WS”, “ADS790WS”, “ADS805WS”, “ADS820WS”, “ADS830WS”, “ADS850WS”, “ADS780HO”, “ADS810CO”, “ADS820HO”, “ADS821NH”, “ADS840NH”, “ADS880MC”, “ADS890MC”, and “ADS920MC” (all trade names) manufactured by American Dye Source, Inc. (Canada); “YKR-2200”, “YKR-2081”, “YKR-2900”, “YKR-2100”, and “YKR-3071” (all trade names) manufactured by Yamamoto Chemicals, Inc.; “SDO-1000 B” (trade name) manufactured by Arimoto Chemical Co., Ltd.; and “NK-3508” and “NKX-114” (trade names) manufactured by Hayashibara Biochemical Laboratories, Inc. However, the dyes are not limited only to these.

Furthermore, as the phthalide compounds that have been reacted with color developing agents, those compounds described in JP-B-3271226 can be usable. Also, phosphoric acid ester metal compounds, for example, complexes of the phosphoric acid esters and copper salts described in JP-A-6-345820 and WO 99/10354 can also be usable. Furthermore, fine particles having light absorption characteristics in the near-infrared region and having a volume average particle size of preferably 0.3 μm or less, more preferably 0.1 μm or less, and particularly preferably 0.08 μm or less, can also be usable. Examples thereof include metal oxides such as yttrium oxide, tin oxide and/or indium oxide, copper oxide, and iron oxide; and metals such as gold, silver, palladium and platinum. Furthermore, products produced by adding metal ions such as the ions of copper, tin, indium, yttrium, chromium, cobalt, titanium, nickel, vanadium and rare earth elements to particles of glass or the like having a volume average particle size of 5 μm or less, and more preferably 1 μm or less, can also be usable. Furthermore, metal ions can also be incorporated into microcapsules. In that case, the volume average particle size of the capsule is preferably 10 μm or less, more preferably 5 μm or less, and even more preferably 1 μm or less. Products produced by adsorbing metal ions of copper, tin, indium, yttrium, and rare earth metals to ion exchanger particles can also be usable. The ion exchanger particles may be resin particles or inorganic particles. Examples of the inorganic particles include amorphous zirconium phosphate, amorphous zirconium silicate, amorphous zirconium hexametaphosphate, layered zirconium phosphate, network-like zirconium phosphate, zirconium tungstenate, and zeolites. Examples of the resin particles include ion exchange resins and ion exchange celluloses, which are conventionally usable.

Most preferred examples of the photothermal conversion agent particularly preferably usable in the present invention include carbon black from the viewpoint of stability and efficiency of photothermal conversion. As carbon black, only if there is no such problem as dispersion instability in the composition constituting the relief-forming layer, any of carbon blacks usually usable for various applications such as coloring, rubber and dry battery is preferably usable, in addition to products falling within standards classified by ASTM.

The carbon black cited here also includes, for example, furnace black, thermal black, channel black, lampblack, acetylene black, etc. Black colorants such as carbon black can be usable for the preparation of the thermally curable resin composition as a color chip or a color paste previously dispersed in nitrocellulose or a binder, while using a dispersing agent if necessary for making the dispersion easy. Such chips and pastes can easily be obtainable as commercial products.

In the present invention, it is also possible to use carbon blacks having a relatively low specific surface area and relatively low DBP absorption, and microfabricated carbon blacks having a large specific surface area.

Examples of the favorable commercial products of carbon black include Printex U (registered trade mark), Printex A (registered trade mark) and Spezialschwarz 4 (registered trade mark) (all are manufactured by Degussa), SEAST 600 ISAF-LS (manufactured by Tokai Carbon Co., Ltd.), Asahi #70 (N-300) and Asahi #80 (N-220) (manufactured by ASAHI CARBON CO., LTD.), etc.

According to the present invention, a carbon black having an amount of DBP oil absorption of less than 150 ml/100 g is preferable, from the viewpoint of the dispersibility in the resin composition for laser engraving.

For the selection of such a carbon black, for example, reference can be made to ‘Carbon Black Binran’ (Carbon Black Handbook) edited by the Carbon Black Association.

When a carbon black having an amount of oil absorption of less than 150 ml/100 g is usable, satisfactory dispersibility in the relief-forming layer can be obtainable, which is preferable. On the other hand, when a carbon black having an amount of DBP oil absorption of 150 ml/100 g or more is usable, the dispersibility in the coating liquid for relief-forming layer tends to deteriorate, and since aggregation of carbon black is likely to occur, the sensitivity becomes non-uniform, which is not preferable. Furthermore, for the purpose of preventing aggregation, it is necessary to intensify the dispersion of carbon black at the time of preparing the coating liquid.

As a method of dispersing Component D, known dispersion techniques that are usable in the ink production or toner production can be employed. Examples of dispersion machines include an ultrasonic dispersion machine, a paint shaker, a sand mill, an attritor, a pearl mill, a super mill, a ball mill, an impeller, a disperser, a KD mill, a colloid mill, a dynatron, a three-roll mill, and a pressure kneader. The details are described in Saishin Ganryo Ohyo Gijutsu (Current Pigment Application Technologies), published by CMC Publishing Co., Ltd. (1986).

The content of Component D depends on the numerical value of the molecular extinction coefficient characteristic to the molecule, and is preferably in the range of 0.1 to 15 mass % relative to the total weight of the composition for laser engraving, more preferably 0.5 to 10 mass %, and particularly preferably 1 to 8 mass %.

The volume-average particle size of Component D is preferably in the range of 0.001 to 10 μm, more preferably 0.05 to 10 μm, and particularly preferably 0.1 to 7 μm.

The volume-average particle size of Component D may be measured by using a laser-scattering type particle size distribution analyzer.

### <Other Additives>

Other components can be added in the curable resin composition and/or resin layer as appropriate according to the intended use and the production method. Other preferred components are exemplified below.

### Thermal Polymerization Inhibitor

The curable resin composition may comprise a small amount of a thermal polymerization inhibitor in order to inhibit undesired thermal polymerization of the compound having a polymerizable ethylenically unsaturated bond during the production process or the storage of the composition. Examples of the suitable thermal polymerization inhibitors include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), and a cerium (I) salt of N-nitrosophenylhydroxylamine.

The addition amount of the thermal polymerization inhibitor in the photosensitive layer is preferably in the range of from 0.01 to 10 mass % based on the total weight of solids in the thermally polymerizable resin composition.

### Filler

The filler may be any of an organic compound, an inorganic compound, or a mixture thereof. Examples of the organic compound include carbon nanotubes, fullerene, and graphite. Examples of the inorganic compound include silica, alumina, aluminum, and calcium carbonate.

### (Resin Layer)

The flexographic printing plate precursor of the present invention has the resin layer at the substrate-side of the cured layer of the curable resin composition. Hereinafter, the resin layer will be described.

The resin layer is formed of a material which has a low oxygen transmission coefficient and cushioning properties. The “cushioning properties” means that the resin layer has elasticity supporting the relief-forming layer. When the precursor is used as a printing plate, the resin layer functions to reduce the pressing force resulting from printing.

The Shore A hardness of the resin layer is 20° to 70°. The Shore A hardness is measured based on Shore A hardness specified by JIS K6253. The Shore A hardness is a value measured by a type-A durometer (a spring type rubber durometer) that presses a penetrator (called a pressing needle or indenter) into the surface of a measurement target so as to deform it, measures the amount of deformation (indentation depth), and converts the amount into a numerical value. At this time, a specimen in which 6 sheets of the resin layers having a thickness of 1 mm have been superposed on one another is used, and the hardness is measured at 25° C.

Moreover, the oxygen transmission coefficient at 25° C. of the resin layer is equal to or lower than 15 cm³·cm/m²·day·atm. The oxygen transmission coefficient is measured by the method described in examples.

If the oxygen transmission coefficient is within the above range, when the curable resin composition is cured, excellent adhesiveness is exhibited in the interface in which the curable resin composition (to be a relief-forming layer by curing) comes into contact with the resin layer. Presumably, this is because the polymerization reaction of the polymerizable compound in the thermosetting resin layer may sufficiently proceed, the addition polymerization reaction of the ethylenically unsaturated compound in the curable resin composition may sufficiently proceed, and consequentially, the adhesiveness between the curable resin composition and the resin layer adjacent thereto may be improved, and the amount of the ethylenically unsaturated compound oozing out to the interface may be reduced.

The resin layer has a Shore A hardness of 20° to 70° and the aforementioned oxygen transmission coefficient. In the following description, the resin layer will be also referred to as a “specific resin layer” for convenience.

In the process for producing a flexographic printing plate precursor, the specific resin layer plays a role of preventing curing inhibitory action caused by oxygen in the air during the curing reaction of the curable resin composition, by making the curable resin composition layer, which has been disposed on a temporary support, interposed between the specific resin layer and the support, in a position opposite to the side of the temporary support.

The specific resin layer also plays a role of elastically supporting the relief layer, in the position between the relief layer and the substrate in the flexographic printing plate.

In the present invention, as the resin layer, it is preferable to use rubber-based materials having a high degree of oxygen barrier properties or to use materials obtainable by adding a plasticizer or the like to highly-polar polymers such as polyvinyl alcohol (PVA) and softening the resultant.

Examples of the rubber-based materials usable for the specific resin layer include butyl rubber (IIR), polysulfide rubber, epichlorohydrin rubber, nitrile rubber (NBR), and fluororubber. Moreover, chloroprene rubber (neoprene, CR), an ethylene-propylene-diene terpolymer (EPDM), styrene butadiene rubber (SBR), and the like can also be usable. Among these, butyl rubber (IIR), high-nitrile rubber (NBR), and epichlorohydrin rubber are preferable.

Furthermore, the rubber-based materials usable for the resin layer may be unvulcanized rubber obtainable by removing a vulcanizing agent and a vulcanizing aid from the compounding of the rubber composition.

For the resin layer, butyl rubber is preferably usable. In addition to butyl rubber, examples of butyl-based rubber include halogenated butyl rubber such as brominated butyl rubber and chlorinated butyl rubber, and the like.

Commercially available products of the butyl rubber can be usable, and examples thereof include Buty 268, CHLOROBUTYL 1066, and Buty 268 manufactured by JAPAN BUTYL Co., Ltd.

Nitrile rubber is also preferably usable for the resin layer. In order to reduce the oxygen transmission coefficient, it is preferable to use nitrile rubber with a acrylonitrile content (AN %) of equal to or greater than 31%. The acrylonitrile content is more preferably equal to or greater than 36%, and even more preferably equal to or greater than 43%. In the present invention, the nitrile rubber is also referred to as “high-nitrile rubber”.

Commercially available products of the nitrile rubber can be usable, and examples thereof include Nipol DN003, Nipol 1041, and Nipol DN101 manufactured by ZEON CORPORATION.

A vulcanizing agent, a vulcanizing accelerator, a vulcanizing-accelerating aid, an antioxidant, a plasticizer, a softener, a filler, and the like that are generally usable in the rubber industries can be mixed in the rubber-based materials. Moreover, as a filler, carbon black may be mixed in the rubber-based materials.

The oxygen transmission coefficient at 25° C. of the resin layer usable in the present invention is equal to or lower than 15 cm³·cm/m²·day·atm. If the oxygen transmission coefficient is not within the above range, when the curable resin composition is cured, excellent adhesiveness is not exhibited in the interface in which the curable resin composition (to be a relief-forming layer by curing) comes into contact with the resin layer. Presumably, this is because the polymerization reaction of the polymerizable compound in the thermosetting resin layer may sufficiently proceed, the addition polymerization reaction of the ethylenically unsaturated compound in the curable resin composition may sufficiently proceed, and consequentially, the adhesiveness between the curable resin composition and the resin layer adjacent thereto may be improved, and the amount of the ethylenically unsaturated compound oozing out to the interface may be reduced.

The oxygen transmission coefficient at 25° C. and under 1 atm of the resin layer used in the present invention is within a range of equal to or lower than 15 cm³·cm/m²·day·atm, preferably equal to or lower than 4.5 cm³·cm/m²·day·atm, and more preferably equal to or lower than 1 cm³·cm/m²·day·atm. The lower limit of the oxygen transmission coefficient is not particularly limited, but it is preferable for the coefficient to be equal to or higher than 0.001 cm³·cm/m²·day·atm.

Several types of resins can be usable for the resin layer, and as described above, the resins are roughly classified into rubber-based materials having a high degree of oxygen barrier properties and plasticized water-soluble polymer compounds.

The rubber-based materials are as described above, and the plasticized water-soluble polymers will be described below.

The water-soluble polymer compounds are preferably polymers relatively excellent in crystallinity. Specific examples thereof include water-soluble polymers such as polyvinyl alcohol, a vinyl alcohol-ethylene copolymer, a vinyl alcohol-vinyl phthalate copolymer, a vinyl acetate-vinyl alcohol-vinyl phthalate copolymer, a vinyl acetate-crotonic acid copolymer, polyvinylpyrrolidone, acidic celluloses, gelatin, gum arabic, polyacrylic acid, and polyacrylamide. With regard to these polymers, one type thereof can be used on its own, or two or more types thereof can be used by being mixed with each other. Among these, polyvinyl alcohol and a vinyl alcohol-ethylene copolymer are preferable.

A portion of the polyvinyl alcohol used for the resin layer may be substituted with ester, ether, and acetal so as to obtain required oxygen barrier properties and water solubility, as long as the polyvinyl alcohol contains an unsubstituted vinyl alcohol unit. Also, a portion of the polyvinyl alcohol may contain other copolymerization components. Specific examples thereof include polyvinyl alcohols which are hydrolyzed by 71% to 100% and in which the number of polymerization repeating units is within a range from 300 to 2,400. Specifically, the examples include PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613, L-8, L-9, and the like manufactured by KURARAY CO., LTD.

Furthermore, carboxyl group-modified polyvinyl alcohol, cation-modified polyvinyl alcohol, acetoacetyl-modified polyvinyl alcohol, sulfonic acid-modified polyvinyl alcohol, and the like can also be preferably usable. Specific examples thereof include T-330H, T-330ST, T-350, T-230, T-215, K-210, Z-200, Z-200H, Z-210, Z-100, F-78 (all manufactured by Nippon Synthetic Chemical Industry Co., Ltd.), and the like.

The content of the polyvinyl alcohol in the hydrophilic resin layer is preferably within a range from 0 to 100 mass %, more preferably within a range from 50 to 100 mass %, and even more preferably within a range from 75 to 100 mass % expressed in terms of a solid content mass.

Examples of resin components other than the polyvinyl alcohol contained in the resin layer include, for example, water-soluble polymers such as cellulose derivatives, polyvinylpyrrolidone, gelatin, polyacrylic acid, polyacrylamide, and a vinylpyrrolidone-vinyl acetate copolymer, non-water-soluble polymer compounds such as polyethylene, polypropylene, polyethylene terephthalate, polystyrene, polycarbonate, nylon, polyamide, and silicone, and the like.

Moreover, as other binder components of the resin layer, polymers containing vinylpyrrolidone as a structural unit are preferable, and examples thereof include polyvinylpyrrolidone or a copolymer of vinylpyrrolidone and vinyl acetate and the like.

When the polymers containing polyvinylpyrrolidone as a structural unit are used, the proportion of the vinylpyrrolidone structural unit in the hydrophilic resin layer is not particularly limited, but the proportion is preferably within a range from 5 to 100 mass %, and more preferably within a range from 10 to 50 mass %.

Various organic or inorganic compounds may be added to the resin layer, in addition to the polyvinyl alcohol and other resin components. The organic or inorganic compounds are preferably usable by being plasticized by the plasticizer described below. Moreover, a surfactant may be added to the resin layer so as to improve coatability of the resin layer to be disposed onto the thermosetting resin composition by coating.

It is preferable to control the oxygen barrier properties by using polyvinyl alcohol (PVA) having a high degree of oxygen barrier properties concurrently with a resin having oxygen barrier properties lower than that of PVA and regulating the content ratio between PVA and the resin. In particular, as the resin having a low degree of oxygen barrier properties, the polyvinylpyrrolidone (PVP) or derivatives thereof are preferably usable. Herein, the content ratio of PVA/PVP (or derivatives thereof) is equal to or lower than 10 in terms of mass. The weight average molecular weight of the (co)polymer such as PVA and the like usable herein is within a range from 2,000 to 10,000,000. The weight average molecular weight is preferably within a range from 10,000 to 1,000,000, and more preferably from 20,000 to 100,000.

The ratio of the content of PVA to the content of PVP (PVA/PVP) is preferably from 0.5 to 10, and particularly preferably from 4 to 10, in terms of mass.

### Plasticizer

When being used alone, the water-soluble polymer compound such as polyvinyl alcohol exhibits a high Shore A hardness due to hydrogen bonds formed by the hydroxyl groups contained in the polymer compound. Accordingly, it is preferable to use the compound for the resin layer after appropriately plasticizing the polymer compound.

A plasticizer has a function of softening the resin layer usable in the present invention and is preferably compatible with the binder polymer. Examples of the plasticizer include diethylene glycol, dioctyl phthalate, didodecyl phthalate, triethylene glycol dicaprylate, dimethyl glycol phthalate, tricresyl phosphate, dioctyl adipate, dibutyl sebacate, triacetyl glycerin, polyglycerin, and the like. Among these, polyglycerin is preferable, and all of the plasticizers are preferably added in an amount of 10 to 60 mass %, and more preferably added in an amount of 20 to 50 mass %, with respect to the total solid mass content (non-volatile fraction) of the resin composition of the resin layer.

The polyglycerin has a structure in which hydroxyl groups of 1-position and 3-position of glycerin have been condensed by ether bonds, and a degree of polymerization thereof is 10 on an average. The polyglycerin in the form of a 70% aqueous solution is on the market.

If the amount of the plasticizer added is too much, the oxygen transmission coefficient increases, and the curing reaction of the curable resin composition tends to be inhibited. Inversely, if the amount of the plasticizer added is too small, the resin layer becomes hard, and the adhesiveness between the resin layer and the relief-forming layer deteriorates. Consequentially, the resin layer tends to be easily peeled off, and the Shore A hardness thereof tends to become too high.

### Support

In the printing plate precursor for laser engraving of the present invention, the substrate is a support on which the resin layer and the cured layer of the curable resin composition are laminated on each other in this order. The substrate is preferably excellent in dimensional stability and may be either a sheet-like substrate or a cylindrical substrate.

In the flexographic printing plate precursor for laser engraving of the present invention, a preferably usable support is a material having flexibility and excellent dimensional stability, and examples thereof include a polyethylene terephthalate film (PET), a polyethylene naphthalate film (PEN), a polybutylene terephthalate film and a polycarbonate film. The thickness of the support is preferably 50 to 350 μm, more preferably 100 to 250 m. When within this numerical range, mechanical properties and shape stability of the printing plate precursor or handling properties of making the printing plate are excellent, which is preferable. Also, in order to enhance the adhesion between the support and the resin layer, a known adhesive conventionally used for such a purpose may be provided on the support surface, if desired.

Furthermore, the adhesive property to the resin layer or adhesive layer can be enhanced by applying a physical or chemical treatment to the surface of the support for use in the present invention. Examples of the physical treatment include a sand blast method, a wet blast method of jetting a particle-containing liquid, a corona discharge treatment, a plasma treatment, and an ultraviolet ray or vacuum ultraviolet ray irradiation treatment. Examples of the chemical treatment include a strong acid or strong alkali treatment, an oxidant treatment, and a coupling agent treatment.

### Coloring Agent

Furthermore, a coloring agent such as a dye or pigment may be added for the purpose of coloring the curable resin composition or the resin layer used in the present invention. The property such as visibility of an image area and compatibility with an image densitometer, can thereby be improved.

The coloring agent is particularly preferably a pigment. Specific examples of the coloring agent include pigments such as phthalocyanine type pigments, azo type pigments, carbon black or titanium oxide, and dyes such as Ethyl Violet, Crystal Violet, azo dyes, anthraquinone type dyes or cyanine dyes. The amount of the coloring agent is preferably in the range of 0.5 to 10 mass % relative to the total solids content of the resin composition of the resin layer.

(Process for Producing Flexographic Printing Plate Precursor for Laser Engraving)

The process for producing a flexographic printing plate precursor for laser engraving of the present invention includes steps of forming a curable resin composition layer by coating a curable resin composition, which comprises (Component A) an ethylenically unsaturated compound, (Component B) a thermal polymerization initiator, and (Component C) a binder, onto a temporary support; forming a resin layer, which has an oxygen transmission coefficient of equal to or lower than 15 cm³·cm/m²·day·atm and a Shore A hardness of 20° to 70°, on the curable resin composition layer; and curing the curable resin composition layer in the order mentioned. The process also includes a step of peeling off the temporary support and laminating a substrate to be used at the time of printing on the resin layer in the additional order, after the above steps.

The step of forming a resin layer is preferably a step of bonding a sheet-like resin layer onto the curable resin composition layer.

Hereinafter, the flexographic printing plate precursor for laser engraving will be described mainly about the points that have not been described so far.

Hereinafter, the essential steps of the process for producing a flexographic printing plate precursor will be described.

The first essential step is a step of forming a curable resin composition layer by coating a curable resin composition, which comprises (Component A) an ethylenically unsaturated group, (Component B) a thermopolymerization initiator, and (Component C) a binder, onto a temporary support.

Component A to Component C are as described above. The curable resin composition containing these essential components may be formed into a curable resin composition layer as necessary by a process in which the curable resin composition is coated onto the temporary support by being made into a solution supplemented with a solvent dissolving those essential components, and then the solvent is removed.

As another process, it is also possible to adopt a process in which the solvent is removed from the coating solution of the curable resin composition, and then the resultant is melt-extruded onto the temporary support.

Each of the layers may be provided by coating one by one, or the plurality of layers may be provided by coating at the same time. However, in the present invention, it is preferable that the curable resin composition be provided onto the temporary support by coating, and then the resin layer be provided by coating.

As the temporary support, it is preferable to use materials which have flexibility and are excellent in dimensional stability. Preferable examples thereof include a polyethylene terephthalate (PET) film, a polyethylene naphthalate (PEN) film, a polybutylene terephthalate film, and polycarbonate. In view of mechanical characteristics and shape stability of the precursor, handleability at the time of making printing plate, and the like, the thickness of the support is 50 to 350 μm, and preferably 100 to 250 μm.

The temporary support preferably has appropriate adhesiveness that makes it possible for the support to be peeled off after the cured layer of the curable resin composition is formed.

The next essential step is a step of forming a resin layer, which has an oxygen transmission coefficient of equal to or lower than 15 cm³·cm/m²·day·atm and a Shore A hardness of 20° to 70°, on the curable resin composition layer.

The materials used for the resin layer are as described above.

The resin layer is provided onto the curable resin composition layer, which has been formed on the temporary support, by coating, or the resin layer is laminated on the curable resin composition layer by being formed into a sheet-like layer. When the sheet-like resin layer is laminated, the thickness thereof is controlled to be a level required to yield the above oxygen transmission coefficient.

The subsequent essential step is a step of curing the curable resin composition layer.

The step of curing is a step of radically polymerizing and curing Component A by using the polymerization-initiating ability of Component B. As described above, when the curable resin composition comprises carbon black as Component D, the curable resin composition layer is preferably cured by using a thermal polymerization initiator. Herein, even after the curing reaction, the relief-forming layer has flexibility required for flexographic printing so as to form a flexographic printing plate.

Examples of heating means for performing thermal curing include a method of heating the laminate for a predetermined time in a hot air oven or in a far-infrared oven, and a method of bringing the laminate into contact with a heated roll for a predetermined time.

The thermal curing of the curable resin composition layer has the following advantages. First, the cross-sectional shape of a relief to be formed after laser engraving becomes sharp, and second, viscosity of the engraving residue generated at the time of laser engraving is suppressed.

The final step is a step of peeling off the temporary support and laminating a substrate on the resin layer.

The temporary support and the substrate may be the same as or different from each other. As the temporary support, a support which is of the same type as the substrate may be used. Herein, the temporary support preferably has an oxygen transmission coefficient low enough for preventing the influence of oxygen in the air during the curing reaction of the curable resin composition.

### Protection Film, Slip Coat Layer

For the purpose of preventing scratches or dents on the surface of the flexographic printing plate precursor, a protection film may be provided on the outermost surface of the flexographic printing plate precursor. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable. The above-mentioned temporary support itself may be used as a protection film.

In order to mold the flexographic printing plate precursor for laser engraving of the present invention into a sheet form or a cylindrical form, the conventional resin-molding methods can be used. For example, a casting method and a method of extruding the resin from a nozzle or dies using a machine, for example, a pump or an extruder and adjusting the thickness by a blade or calendering with rollers are exemplified. In such cases, it is also possible to perform the molding accompanied with heating within a range wherein the performance of the resin composition is not damaged. Also, a rolling treatment, a grinding treatment or the like may be carried out, if desired. Ordinarily, the resin composition is molded on an underlay referred to as a back film composed of a material, for example, PET or nickel in many cases. There is also a case where the resin composition is molded directly on a cylinder of a printing machine. Further, a cylindrical support made of fiber reinforced plastic (FRP), plastic or metal can also be used. As the cylindrical support, a hollow cylindrical support having a constant thickness can be used for the purpose of weight saving. The role of the back film or cylindrical support is to ensure the dimensional stability of the printing plate precursor. Therefore, a material with high dimensional stability should be selected.

Specific examples of the support material include a polyester resin, a polyimide resin, a polyamide resin, a polyamideimide resin, a polyetherimide resin, a polybismaleimide resin, a polysulfone resin, a polycarbonate resin, a polyphenyleneether resin, a polyphenylenethioether resin, a polyethersulfone resin, a liquid crystalline resin formed by a full aromatic polyester resin, a full aromatic polyamide resin, and an epoxy resin.

Further, the resins may be used in the form of a laminate. For example, a sheet composed of a full aromatic polyamide film having a thickness of 4.5 μm on both surfaces of which a polyethylene terephthalate layer having a thickness of 50 μm is laminated is exemplified. Moreover, a porous sheet, for example, a cloth formed by knitting of fibers, a nonwoven cloth or a film having fine pores can be used as the back film. In the case of using a porous sheet as the back film, when the relief-forming resin composition is impregnated into the pores of the sheet and then subjected to curing, a high adhesive property can be achieved by the integration of the cured relief-forming resin layer and the back film.

Examples of the fibers for the formation of cloth or nonwoven cloth include inorganic fibers such as glass fibers, alumina fibers, carbon fibers, alumina-silica fibers, boron fibers, high silicon fibers, potassium titanate fibers and sapphire fibers, natural fibers such as cotton and hemp, semisynthetic fibers such as rayon and acetate, and synthetic fibers such as nylon, polyester, acrylic resin, vinylon, polyvinyl chloride, polyolefin, polyurethane, polyimide and aramide. Furthermore, cellulose produced by a bacterium is a high crystalline nanofiber and is a material capable of making thin nonwoven fibers having high dimensional stability.

The thickness of the cured layer of the flexographic printing plate precursor for laser engraving of the present invention may be set to any value according to the intended use thereof, and is preferably from 0.005 to 10 mm and more preferably from 0.05 to 7 mm.

The thickness of the resin layer of the flexographic printing plate precursor for laser engraving of the present invention is preferably 0.1 to 1.6 mm, and particularly preferably 0.2 to 1.0 mm. If the thickness is within this range, the resin layer exerts a strong oxygen barrier effect in the step of curing the curable resin composition and functions as a cushion layer at the time of flexographic printing.

### (Process for Making Flexographic Printing Plate)

The process for making a flexographic printing plate of the present invention includes steps of preparing the flexographic printing plate precursor of the present invention and laser-engraving the flexographic printing plate precursor.

### Step of Laser-Engraving

In the laser-engraving step, a relief image is prepared on the printing plate precursor by making digitalized data based on the image to be formed and operating a laser device based on the digitalized data utilizing a computer.

The laser used in the laser engraving can be any laser as long as it contains a wavelength at which the printing plate precursor has absorption. In order to carry out the engraving with high speed, a laser having a high power is desirable. One preferable example of the laser is a laser having an emitting wavelength in an infrared region or near infrared region, such as a carbon dioxide laser, a YAG laser, a semiconductor laser, and a fiber laser. Further, an ultraviolet laser having an emitting wavelength in an ultraviolet region, for example, an excimer laser, a YAG laser wavelength-converted to the third harmonic or the fourth harmonic, or a copper vapor laser is able to conduct ablation processing which cleaves a bond between organic molecules and thus is suitable for microfabrication. A laser having an extremely high peak power, such as a femtosecond laser, can also be employed. The laser irradiation may be performed continuously or pulsewise.

Although the engraving with a laser is conducted under oxygen-containing gas, ordinarily in the presence of air or in an air flow, it can be conducted under carbon dioxide gas or nitrogen gas. After the completion of the engraving, the flexographic printing plate may be subjected to a washing step (rinsing step) for removal of the engraved residue in powdery or liquid state occurred on the surface of the flexographic printing plate by using an appropriate method, for example, a method of washing out, for example, with a solvent or water containing a surfactant, a method of spray-washing an aqueous cleaning agent, for example, by a high-pressure sprayer, or a method of spray-washing high-pressure steam.

The flexographic printing plate precursor for laser engraving or flexographic printing plate of the present invention can be applied to various usages, such as a stamp, a seal, a design roll for embossing, a relief image for patterning an insulator, resistor or conductive paste used for the production of electronic components, a relief image for a mold material of ceramic products, a relief image for display, such as an advertising board or a sign board, or a prototype or matrix of various moldings, as well as the relief image for a printing plate.

Surface Treatment after Laser Engraving

A decrease in tackiness on the surface of the printing plate or improved ink wetting properties is also achieved by forming a modifying layer on the surface of the relief printing plate having the concavo-convex pattern according to the present invention. As the modifying layer, a film layer treated with a compound reacting with hydroxy group on the surface of the layer, such as a silane coupling agent and a titanium coupling agent, or a polymer film containing porous inorganic particles is exemplified. The silane coupling agent widely used is a compound having a functional group in its molecule, which has high reactivity with hydroxy group on the surface of a base material. Examples of such functional group include a trimethoxysilyl group, a triethoxysilyl group, a trichlorosilyl group, a dimethoxysilyl group, a diethoxysilyl group, a dichlorosilyl group, a monomethoxysilyl group, a monoethoxysilyl group, and a monochlorosilyl group. Further, at least one of the functional groups is present in the molecule and the compound is fixed on the surface of the substrate by the reaction of the functional group with hydroxy group on the surface of the substrate. Further, as the compound constituting the silane coupling agent, the compound having at least one functional group selected from the group consisting of an acryloyl group, a methacryloyl group, an active halogen-containing amino group, an epoxy group, a vinyl group, a perfluoroalkyl group, and a mercapto group or the compound having a long chain alkyl group can be used. When the molecule of the coupling agent fixed on the surface particularly has a polymerizable reactive group, the more solid coating film can be formed by irradiating the surface with light, heat or an electron beam after the fixing on the surface to form crosslinkage.

A surface treating solution is prepared by diluting the above-described coupling agent with a mixed solution of water and an alcohol or of aqueous acetic acid and an alcohol, as the need arises. The concentration of the coupling agent in the treating solution is preferably from 0.05 to 10.0 mass %.

A method of treatment with the coupling agent is described below. The treating solution containing the coupling agent is used by coating on the surface of the printing plate precursor or the surface of the printing plate after the laser engraving. The method for coating the treating solution of the coupling agent is not particularly restricted and, for example, a dip coating method, a spray coating method, a roll coating method, or a brush coating method can be appropriately used. Further, although the coating treatment temperature and coating treatment time are also not particularly limited, the treatment temperature is preferably from 5° C. to 60° C. and the treatment time is preferably from 0.1 to 60 seconds. The drying of the treatment solution layer on the surface of the printing plate is preferably carried out with heating and the heating temperature is preferably from 50° C. to 150° C.

As the method of treatment with the coupling agent, can be employed a method in which by irradiating the surface of the printing plate with light of a vacuum ultraviolet region having a wavelength of 200 nm or less, such as with a xenon excimer lamp or exposing the surface of the printing plate to a high energy atmosphere, such as a plasma, prior to the treatment of the surface of the printing plate with the coupling agent, hydroxy groups are generated on the surface of the printing plate and the coupling agent is fixed at a high density.

Further, when the layer containing the inorganic porous particles is revealed on the surface of the printing plate, by treating the surface under a high energy atmosphere, for example, a plasma, to somewhat remove the organic substance layer of the surface by etching, fine concavities and convexities can be formed on the surface of the printing plate. According to the treatment, the effects of decrease in tackiness on the surface of the printing plate and improvement in ink wetting properties due to ease of ink absorption of the inorganic porous particles revealed on the surface can be expected.

### Rinsing Step

The process for making a flexographic printing plate of the present invention preferably includes a step of rinsing the engraved surface with water or a liquid containing water as a main component after the step of laser-engraving, for the purposes of removing engraved residue having adhered to the engraved surface and for the purpose of dissolving and removing the hydrophilic resin layer.

Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraving residue cannot be eliminated, a rinsing liquid to which a soap or a surfactant is added may be used.

Moreover, in the present invention, the hydrophilic resin layer is preferably an alkali-soluble resin layer and is preferably rinsed with an aqueous alkaline solution as the rinsing liquid.

The rinsing liquid in the present invention is preferably alkaline. The pH of the rinsing liquid usable in the present invention is at least 9, more preferably at least 10, and yet more preferably at least 11. The pH of the rinsing liquid is preferably no greater than 14, more preferably no greater than 13.5, and yet more preferably no greater than 13.2, and especially preferably no greater than 12.5. When in the above-mentioned range, dissolution and removal of the hydrophilic resin layer becomes easy and removal of the engraved residue becomes easy.

In order to adjust the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may comprise as a solvent other than water a water-miscible solvent such as an alcohol, acetone, or tetrahydrofuran.

The rinsing liquid preferably comprises a surfactant.

From the viewpoint of removability of engraving residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

<Drying Step and Post-Crosslinking Step>

The process for making a flexographic printing plate of the present invention may further includes a drying step and/or a post-crosslinking step, after the rinsing step. The drying step is a step of drying the relief layer which has been laser-engraved and rinsed in the rinsing step. The post-crosslinking step is a step of further crosslinking the relief layer by further applying energy to the relief layer having been laser-engraved.

When a rinsing step is carried out to rinse the engraved surface, it is preferable to add a drying step to dry the engraved relief-forming layer in order to evaporate a rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

According to the present invention, it is possible to obtain a relief printing plate precursor excellent in the adhesiveness between the cured layer of the curable resin composition as a relief-forming layer and the resin layer as a cushion layer, and from the printing plate precursor, it is possible to make a relief printing plate showing a low relief deformation rate.

### EXAMPLES

Hereinbelow, the present invention will be explained in detail with reference to Examples, but the present invention is not limited to these

Furthermore, the parts of the addition amount in Examples represent parts by mass and % represents mass %.

The components used in Examples and Comparative Examples are shown in detail below.

Butyl rubber: IIR sheet butyl plate 65 manufactured by TIGERS POLYMER CORPORATION

High-nitrile rubber: Nipol 1041 (AN 40%) manufactured by ZEON CORPORATION

Epichlorohydrin rubber: Hydrin H75 manufactured by ZEON CORPORATION

PVA: polyvinyl alcohol, Poval PVA 403 manufactured by KURARAY CO., LTD.

Eval: ethylene-vinyl alcohol copolymer, Eval F101B manufactured by KURARAY CO., LTD.

PET film: Lumirror S10 manufactured by TORAY INDUSTRIES, INC.

NR: black rubber plate 40% <40> manufactured by TIGERS POLYMER CORPORATION

PG: polyglycerin, PGL #800V manufactured by Yokkaichi Chemical Company, Limited

### Example 1

### Preparation of Curable Resin Composition

50 parts of “Denka butyral #3000-2” (polyvinyl butyral derivative manufactured by DENKI KAGAKU KOGYO KABUSHIKI KAISHA, Mw=90,000) as Component C, 30 parts of propylene glycol monomethyl ether acetate as a solvent, and 17 parts of ethanol were put into a three-neck flack equipped with a stirring blade and a cooling tube, and the polymer was dissolved by being heated for 120 minutes at 70° C. under stirring. Thereafter, the solution was cooled to 40° C. and stirred for 30 minutes. Subsequently, 15 parts of “Light acrylate 14EG-A” (diacrylate of polyethylene glycol 600, manufactured by KYOEISHA CHEMICAL Co., LTD.) as (Component A) an ethylenically unsaturated compound (polyfunctional), 4 parts of Blemmer LMA (manufactured by NOF CORPORATION) which is lauryl methacrylate as another ethylenically unsaturated compound (monofunctional), and 1.0 part of t-butylperoxybenzoate (trade name: Perbutyl Z, manufactured by NOF CORPORATION) as (Component B) a polymerization initiator were added thereto, followed by stirring for 10 minutes at 40° C. By this operation, a coating solution 1 of a curable resin composition having fluidity was obtainable.

A spacer (frame) having a thickness of 1.7 mm was placed on a PET film (thickness: 100 μm) as a temporary support, and the coating solution 1 for forming a crosslinkable relief-forming layer obtainable as above was gently cast thereon such that it did not overflow from the space (frame). The resultant was then dried for 1 hour in an oven at 50° C., and the solvent was dried, thereby preparing a cured layer (relief-forming layer; a first layer) of a curable resin composition having a thickness of 1 mm.

Subsequently butyl rubber (IIR sheet butyl plate 65 manufactured by TIGERS POLYMER CORPORATION, thickness: 1 mm) as a second layer (resin layer) was bonded to the first layer such that air did not enter the space between the butyl rubber and the first layer, and the resultant was heated for 3 hours in an oven at 70° C. so as to cure the first layer. Thereafter, the PET film was peeled off, thereby obtaining a flexographic printing plate precursor for laser engraving 1.

### (Preparation of Relief Printing Plate)

As a carbon dioxide laser engraving machine, a high-quality CO₂ laser marker ML-9100 series (manufactured by KEYENCE Corporation, wavelength: 10.6 μm) was used to perform engraving by laser irradiation. The surface of the printing plate precursor from which the PET film had been peeled off was engraved by the carbon dioxide laser engraving machine, under conditions of an output of 12 W, a head speed of 200 mm/sec, and a pitch setting of 2,400 DPI.

### Example 2

A flexographic printing plate precursor for laser engraving 2 was prepared in the same manner as in Example 1, except that a sheet obtained by processing Nipol 1041 (manufactured by ZEON CORPORATION) into a sheet having a thickness of 1 mm by using a hot press machine (G-12 manufactured by Orihara Industrial co., ltd.) was used instead of the butyl rubber used in Example 1.

### Example 3

A flexographic printing plate precursor for laser engraving 3 was prepared in the same manner as in Example 1, except that a sheet obtained by processing Epichlorohydrin rubber (Hydrin H75 manufactured by ZEON CORPORATION) into a sheet having a thickness of 1 mm by using a hot press machine (G-12 manufactured by Orihara Industrial co., ltd.) was used instead of the butyl rubber used in Example 1.

### Example 4

37 parts by mass of Kuraray Poval PVA 403 was added to 30 parts by mass of water and 25 parts by mass of ethanol. The resultant mixture was dissolved by being stirred for 1 hour at room temperature and then stirred for 3 hours at 60° C. Thereafter, 15 parts by mass of polyglycerin (PGL #800V manufactured by Yokkaichi Chemical Company, Limited) was added thereto, thereby obtaining a coating composition for resin layer 4.

Onto the relief-forming layer obtained in Example 1, the coating composition for resin layer 4 was coated in a thickness of 2.0 mm, and then the resultant was dried by being heated for 2 hours in an oven at 60° C. and then for 3 hours in an oven at 70° C. such that a resin layer having a thickness of 1 mm was formed. Thereafter, the PET film was peeled off, thereby obtaining a flexographic printing plate precursor for laser engraving 4.

### Example 5

A flexographic printing plate precursor for laser engraving 5 was obtained in the same manner as in Example 4, except that 37 parts by mass of an ethylene-vinyl alcohol copolymer (Eval F101B manufactured by KURARAY CO., LTD.) was used instead of 37 parts by mass of Kuraray Poval PVA 403 used in Example 4.

### Comparative Example 1

In Comparative Example 1, a flexographic printing plate precursor for laser engraving C1 for comparison was prepared in the same manner as in Example 1, except that a PET film (Lumirror S-10 manufactured by TORAY INDUSTRIES, INC.) having a thickness of 0.1 mm was used instead of butyl rubber sheet in Example 1.

### Comparative Example 2

In Comparative Example 2, a flexographic printing plate precursor for laser engraving C2 for comparison was prepared in the same manner as in Example 1, except that NR (black rubber plate 40% <40> manufactured by TIGERS POLYMER CORPORATION) having a thickness of 1 mm was used instead of butyl rubber sheet in Example 1.

### Comparative Example 3

A flexographic printing plate precursor for laser engraving C3 was prepared in the same manner as in Example 4, except that polyglycerin was not added in Example 4.

### Comparative Example 4

A flexographic printing plate precursor for laser engraving C4 was prepared in the same manner as in Example 4, except that polyglycerin was not added in Example 5.

### (Method for Measuring Oxygen Transmission Coefficient)

The prepared coating solution for forming a hydrophilic resin layer was coated onto a polyethylene film having a high degree of oxygen transmissivity (polyethylene laminate paper prepared by dissolving and removing the gelatin layer on the surface of “Ever-Beauty Paper” manufactured by FUJIFILM Corporation) and then dried, or bonded to the polyethylene film, such that the thickness of the hydrophilic resin layer became 1 mm, thereby preparing samples. According to the test method for gas transmission rate described in JIS-K7126B and ASTM-D3985, the oxygen transmission coefficient (cm³·cm/m²·day·atm) was measured in the atmospheric environment of 25° C. and 60% RH by using OX-TRAN 2/21 manufactured by MOCON Inc.

### (Adhesiveness Test)

At the edge (10 mm) of the sample cut in 20 mm×80 mm, portions in which the cured layer (first layer) and the resin layer (second layer) had adhered to each other were peeled off by hand. Each of the peeled portions of the first layer and the second layer was fixed to a tensil part of a tensilon testing machine and drawn by 100 mm at a peel rate of 50 mm/min, and the load was measured. The value of load at a point in time when the load fell in a stable range was taken as adhesiveness.

The adhesiveness is indicated by a unit of N/cm, and an adhesiveness of equal to or higher than 1.0 N/cm is regarded as being unproblematic.

### (Relief Deformability Test)

A cushion tape (R/bak SA3300 manufactured by ROGERS Corporation) was bonded to the test sample (thickness of 1 mm) in which a linear relief having a height of 500 μm had been formed, and the cross-section thereof was imaged by a microscope.

Next, an indentation of 0.2 mm was made in the sample by using an indentation testing machine. Thereafter, the cross-section thereof was imaged by a microscope so as to obtain a height X of the linear relief.

A relief deformation rate was calculated by the following formula.

[(Height (500 μm) of linear relief before making indentation)−(Height X of linear relief after making indentation)]/(Height (500 μm) of linear relief before making indentation)×100

(Measurement of Conversion Ratio of Monomers in Relief Layer)

Each of the 4 cm² samples of the flexographic printing plate precursors for laser engraving was cut in 2 mm×2 mm by a pair of scissors and subjected to accurate weighing. Thereafter, from the mass ratios of the support, the cured layer (first layer), and the resin layer (second layer) and the compositional ratio of the first layer, the amount of Light acrylate 14EG-A and lauryl methacrylate having been mixed with the flexographic printing plate precursors for laser engraving was calculated as the amount of mixed monomers.

Subsequently, the specimen having undergone accurate weighing was put in a glass tube, and 4.0 g of tetrahydrofuran was put into the tube. The sample was dipped in tetrahydrofuran for 24 hours to extract the residual monomers. After the specimen was left as is for 24 hours at room temperature, the extract was collected, and the quantity of the residual monomers was determined by high-performance liquid chromatography (LC-20AD/SIL-20A manufactured by Shimadzu Corporation, ODS column, flow rate of mobile layer: 1.0 mL/min, THF/buffer=6/4, ODS column).

The conversion ratio of monomers of the relief layer was calculated by the following formula.

(100−Amount of residual monomers/amount of mixed monomers)×100

The obtained results are shown in Table 1. As is evident from Table 1, the examples of the present invention are superior in the adhesion strength and show a smaller relief deformation rate, compared to comparative examples.

As a result of checking a light-and-shade representation of highlight of the image prepared by actually transferring an ink to a printing object, it was confirmed that while the reproducibility of highlight is insufficient in comparative examples, the reproducibility of highlight is excellent in examples. It was also confirmed that in examples showing a low relief deformation rate, printing durability is excellent, and image deterioration is caused to a small extent even when printing is performed for a long time.

TABLE 1

| Examples | | | Thickness | | | | | | |
|---|---|---|---|---|---|---|---|---|---|
| and | Component 1 | | of | Process | Shore A | Oxygen | | Conversion | Relief |
| Comparative | of resin layer | | resin | for | hardness | transmissivity | Adhesiveness | ratio of | deformation |
| examples | (part by | Component 2 | layer | forming | of resin | [cm³ · cm/m² · | test | monomers of | rate |
| (C) | mass) | of resin layer | (mm) | resin layer | layer (°) | day · atom] | (N/cm) | relief layer (%) | (%) |
| 1 | Butyl rubber | None | 1 | Bonding | 64 | 1.1 | 7.2 | 99 | 4 |
| 2 | High-nitrile | None | 1 | Bonding | 65 | 0.9 | 7.1 | 99 | 5 |
| | rubber | | | | | | | | |
| 3 | PVA 403 | PG | 1 | Bonding | 64 | 5 | 5.2 | 95 | 4 |
| | 37 parts | 15 parts | | | | | | | |
| 4 | Eval F101B | PG | 1 | Coating | 64 | 13 | 4.8 | 95 | 5 |
| | 37 parts | 15 parts | | | | | | | |
| 5 | Nylon 6 | None | 1 | Coating | 50 | 10 | 5.1 | 95 | 3 |
| 6 | Epichloro- | None | 1 | Coating | 64 | 4.5 | 6.9 | 99 | 5 |
| | hydrin rubber | | | | | | | | |
| C1 | PET film | None | 0.1 | Bonding | 93 | 21 | 5.1 | 89 | 37 |
| C2 | NR | None | 1 | Bonding | 65 | 44 | 3.2 | 64 | 5 |
| C3 | PVA 403 | None | 1 | Coating | 95 | 1.2 | 6.1 | 95 | 38 |
| C4 | Eval F101B | None | 1 | Coating | 80 | 0.15 | 7.6 | 95 | 32 |

What is claimed is:

1. A process for producing a flexographic printing plate precursor for laser engraving, comprising, in order, steps of:
forming a curable resin composition layer, which comprises (Component A) an ethylenically unsaturated compound, (Component B) a polymerization initiator, and (Component C) a binder, on a temporary support;
forming a resin layer, which has an oxygen transmission coefficient of equal to or lower than 15 cm³·cm/m²·day·atm and a Shore A hardness of 20° to 70°, on the curable resin composition layer; and
curing the curable resin composition layer.

2. The process for producing a flexographic printing plate precursor according to claim 1, wherein the step of curing the curable resin composition layer is a step of thermally curing the curable resin composition layer.

3. The process for producing a flexographic printing plate precursor according to claim 1,
wherein the cured layer of the curable resin composition layer further comprises (Component D) a photothermal conversion agent.

4. The process for producing a flexographic printing plate precursor according to claim 3, wherein Component D is carbon black.

5. The process for producing a flexographic printing plate precursor according to claim 1, wherein the resin layer comprises an elastomer.

6. The process for producing a flexographic printing plate precursor according to claim 1, wherein the resin layer is selected from a group consisting of butyl rubber, epichlorohydrin rubber, nitrile rubber, plasticized polyvinyl alcohol, and a plasticized ethylene-polyvinyl alcohol copolymer.

7. The process for producing a flexographic printing plate precursor according to claim 1, wherein a film thickness of the resin layer is 0.1 to 1.6 mm.

8. The process for producing a flexographic printing plate precursor according to claim 1,
wherein the curable resin composition layer contains a monofunctional ethylenically unsaturated compound and a polyfunctional ethylenically unsaturated compound as Component A, and comprises an organic peroxide as Component B.

9. The process for producing a flexographic printing plate precursor according to claim 1, wherein the curable resin composition layer comprises a resin, which stays in the form of a plastomer at 20° C., as Component C.

10. The process for producing a flexographic printing plate precursor according to claim 1, wherein the step of forming a resin layer is either a step of providing a resin layer onto the curable resin composition layer by coating or a step of bonding a sheet-like resin layer onto the curable resin composition layer.

11. The process for producing a flexographic printing plate precursor according to claim 1, wherein the step of forming a resin layer is a step of bonding a sheet-like resin layer onto the curable resin composition layer.

12. The process for producing a flexographic printing plate precursor according to claim 1, further comprising, after the step of curing the curable resin composition layer, a step of peeling off the temporary support and laminating a substrate on the resin layer.

13. A process for making a flexographic printing plate, comprising steps of: preparing a flexographic printing plate precursor for laser engraving obtained by the production process according to claim 1; and laser-engraving the cured layer of the flexographic printing plate precursor.

14. The process for making a flexographic printing plate according to claim 13, further comprising, after the step of laser-engraving, a step of rinsing the surface of the cured layer with a rinsing liquid.
